(19) United States
(12) Patent Application Publication
(10) Pub. No.: US 2026/0318688 A1
(43) Pub. Date: Oct. 15, 2026

(54) GENERATION OF WAYPOINT GRAPHS FOR ROBOTICS SYSTEMS AND APPLICATIONS

(71) Applicant: NVIDIA Corporation, Santa Clara, CA (US)

(72) Inventor: Ju-Hsuan Hua, Cupertino, CA (US)

(21) Appl. No.: 19/178,571

(22) Filed: Apr. 14, 2025

(51) Int. Cl. G01C 21/20; G06T 7/73

(52) U.S. Cl. CPC G01C 21/20; G06T 7/73; G06T 2207/20072

(57) ABSTRACT

In various examples, sparse waypoint graphs may be generated using occupancy information to allow for efficient and reliable path planning for autonomous or semi-autonomous machines. For instance, the systems and methods of the present disclosure may analyze occupancy maps as 2D images to generate skeletons of free-space and obstacle contours, and strategically place nodes of the waypoint graph along these features. Additional nodes may then be iteratively added to under-represented, free-space regions based on distance metrics. For example, distance maps may be computed to indicate how far each point in the free-space is from the nearest existing node or obstacle, and new nodes may be placed at the most distant points (e.g., “local maxima”) if their distance exceeds a defined threshold. Edges of the waypoint graph may then be defined by connecting the nodes using geometric graph generation models—such as Delaunay triangulation.

### BACKGROUND

In various instances, autonomous and semi-autonomous machines may rely on structured representations of an environment to perform navigation, motion planning, and/or task execution. For instance, occupancy maps, evidence grid maps (EGMs), height maps, and/or other spatial models may be used to encode information about traversable and non-traversable (e.g., obstructed) regions in both structured and unstructured environments, such as warehouses, roadways, indoor facilities, or any other environments. To support path planning, these machines may use waypoint graphs—graph structures in which nodes represent feasible positions and edges represent collision-free transitions between those positions. Such graphs may serve as the basis for efficient routing using search algorithms or for coordination in multi-agent systems, enabling scalable and interpretable decision-making in dynamic or human-shared environments.

However, conventional techniques for generating waypoint graphs often present limitations in balancing efficiency, scalability, and consistency. For instance, while grid-based methods may yield near-optimal paths, their computational costs can be prohibitive—particularly in large, dynamic environments—due to the graph size and the time required for search operations. Visibility graph techniques may also fail to ensure even spatial coverage, and their runtime increases significantly as sampling resolution improves. Additionally, sample-based algorithms may produce inconsistent results across executions, reducing predictability and potentially hindering usability in human-robot environments. These constraints pose challenges for both single-machine navigation and coordinated path planning and scheduling in multi-agent systems.

### SUMMARY

Embodiments of the present disclosure relate to generation of waypoint graphs for autonomous or semi-autonomous systems and applications. Systems and methods are disclosed that may generate sparse waypoint graphs using occupancy grid maps (or generally, using occupancy information) to enable efficient and reliable path planning for autonomous or semi-autonomous machines.

For instance, the systems and methods of the present disclosure may analyze occupancy maps as two-dimensional (2D) images to generate skeletons of free-space and obstacle contours, and strategically place nodes of the waypoint graph along these features. Additional nodes may then be iteratively added to under-represented, free-space regions based on distance metrics. For example, distance maps may be computed to indicate how far each point in the free-space is from the nearest existing node or obstacle, and new nodes may be placed at the most distant points (e.g., “local maxima”) if their distance exceeds a defined threshold. Edges of the waypoint graph may then be defined by connecting the nodes using geometric graph generation models—such as Delaunay triangulation—while ensuring that graph edges comply with predefined safety thresholds. In some examples, the systems and methods of the present disclosure may perform optimization procedures to improve navigability and reduce redundancy. These optimizations may include pruning isolated nodes and small disconnected subgraphs that are unlikely to be useful for path planning, as well as merging clusters of nearby nodes to simplify the graph structure.

In contrast to conventional systems, the systems and methods of the present disclosure, in some embodiments, may generate sparse waypoint graphs from occupancy grid maps using a structured, image-based analysis that enhances spatial coverage, computational efficiency, and operational consistency. For instance, by incorporating skeletonization of free-space and obstacle contour detection, the disclosed systems and methods may strategically place waypoint graph nodes to reflect both navigable pathways and environmental boundaries. Additionally, by leveraging distance transform techniques, the systems and methods of the present disclosure may identify underrepresented regions within the free-space and iteratively add nodes at local maxima to improve coverage without compromising sparsity, in contrast to conventional systems. Further, by adding edges between nodes using geometry-driven models such as Delaunay triangulation, the disclosed systems and methods may establish efficient, collision-free connectivity that preserves navigational reachability while adhering to predefined safety thresholds. In contrast to conventional systems, the disclosed systems and methods may also perform optimization procedures to further simplify waypoint graphs by pruning isolated nodes, removing small, disconnected subgraphs, and merging densely clustered nodes to reduce redundancy without compromising path quality.

### BRIEF DESCRIPTION OF THE DRAWINGS

The present systems and methods for generation of waypoint graphs for autonomous or semi-autonomous systems and applications are described in detail below with reference to the attached drawing figures, wherein:

FIG. 1 is a data flow diagram illustrating an example of a process that may be performed by a system to generate sparse waypoint graphs using occupancy information, in accordance with some embodiments of the present disclosure;

FIG. 2 illustrates an example of an occupancy grid map associated with an environment, in accordance with some embodiments of the present disclosure;

FIG. 3 illustrates an example of an updated version of the occupancy grid map from the example of FIG. 2 based on performing safety-thresholding, in accordance with some embodiments of the present disclosure;

FIG. 4 illustrates an example of a process for placing nodes of a waypoint graph, in accordance with some embodiments of the present disclosure;

FIG. 5 illustrates an example of using a topology of a skeleton graph to position nodes and edges of a waypoint graph, in accordance with some embodiments of the present disclosure;

FIG. 6 illustrates an example in which nodes and edges of the waypoint graph have been added that correspond to perimeters of objects in the occupancy grid map with safety-thresholding, in accordance with some embodiments of the present disclosure;

FIG. 7 illustrates an example of the waypoint graph in which nodes have been added to correspond to points in free-space areas of the occupancy grid map, in accordance with some embodiments of the present disclosure;

FIGS. 8A-8C collectively illustrate an example of adding waypoint graph nodes at locations corresponding to local maxima points that are a threshold distance away from existing nodes, in accordance with some embodiments of the present disclosure;

FIG. 9 illustrates an example of the waypoint graph in which connections have been made between the nodes to create edges, in accordance with some embodiments of the present disclosure;

FIG. 10 illustrates an example of an optimized version of the waypoint graph in which one or more nodes or edges have been strategically removed, in accordance with some embodiments of the present disclosure;

FIGS. 11A and 11B collectively illustrate an example of optimizing a portion of a waypoint graph by merging densely clustered nodes, in accordance with some embodiments of the present disclosure;

FIG. 12 is a block diagram illustrating example detail associated with a system that may perform one or more of the processes and/or methods described herein, in accordance with some embodiments of the present disclosure;

FIG. 13 is a flow diagram illustrating an example of a method for generating a waypoint graph based on occupancy information, in accordance with some embodiments of the present disclosure;

FIG. 14 is a flow diagram illustrating an example of a method for generating and sending a waypoint graph to one or more machines, in accordance with some embodiments of the present disclosure;

FIG. 15 is a flow diagram illustrating an example of a method for updating a waypoint graph, in accordance with some embodiments of the present disclosure;

FIG. 16A is an example of sensor locations having corresponding fields of view or sensory fields for example autonomous or semi-autonomous machines, in accordance with at least some embodiments of the present disclosure;

FIG. 16B is an illustration of an example of component and sensor locations on an autonomous or semi-autonomous vehicle, in accordance with at least some embodiments of the present disclosure;

FIG. 16C is a block diagram of an example system architecture for an autonomous or semi-autonomous vehicle, robot, and/or other machine type, in accordance with at least some embodiments of the present disclosure;

FIG. 16D is a block diagram of an example architecture of a computing system-such as a system-on-a-chip (SoC)—in accordance with at least some embodiments of the present disclosure;

FIG. 16E is a system diagram for communication between cloud-based server(s) and an example autonomous or semi-autonomous vehicle, robot, and/or other machine type, in accordance with at least some embodiments of the present disclosure;

FIG. 17 is a system diagram illustrating a three-computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 18 is a block diagram of an example computing system for generative artificial intelligence (AI), in accordance with at least some embodiments of the present disclosure; and

FIG. 19 is a block diagram of an example computing device, in accordance with at least some embodiments of the present disclosure.

### DETAILED DESCRIPTION

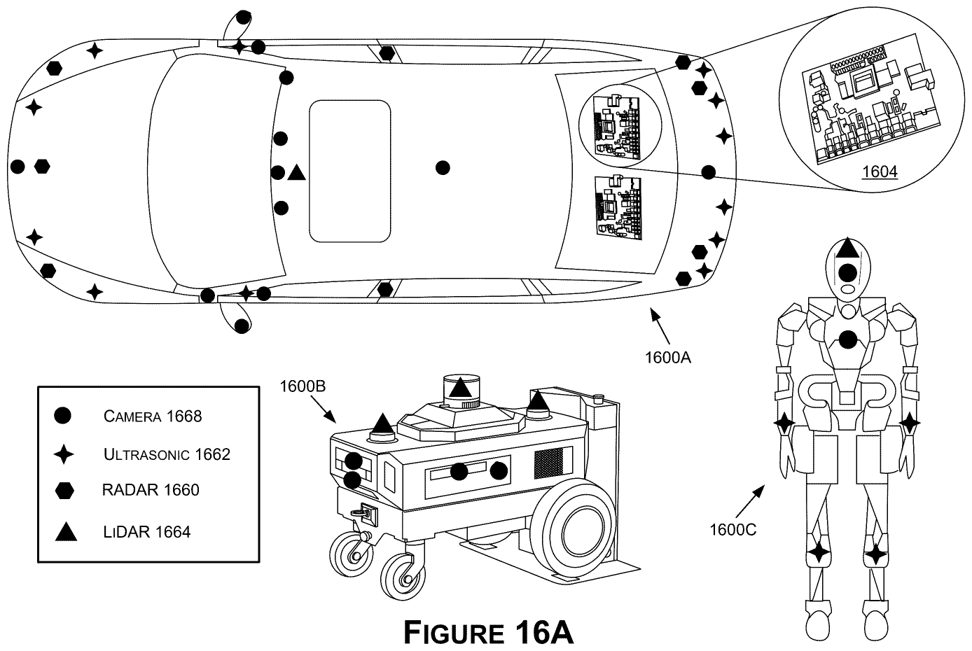

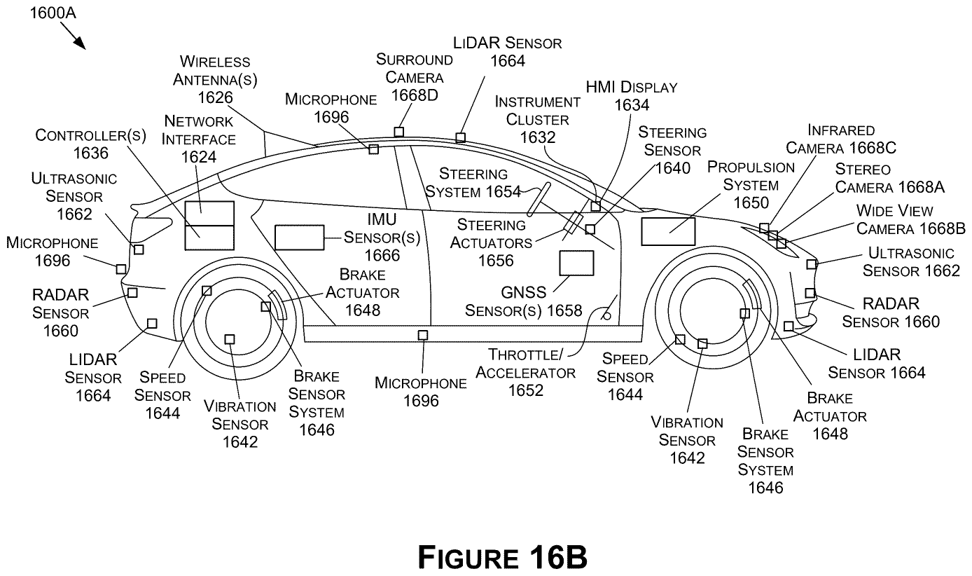

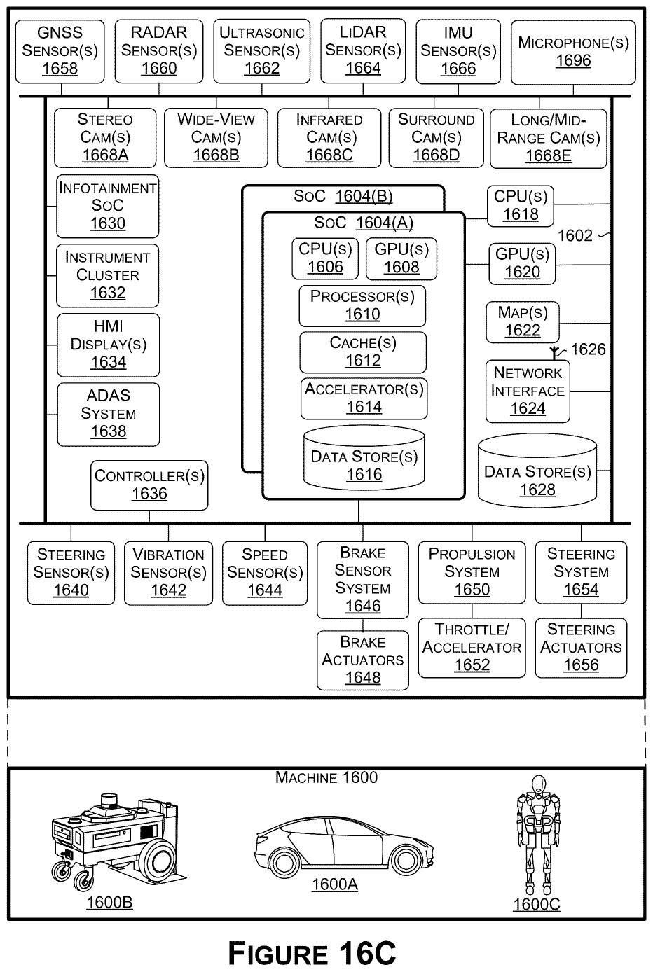

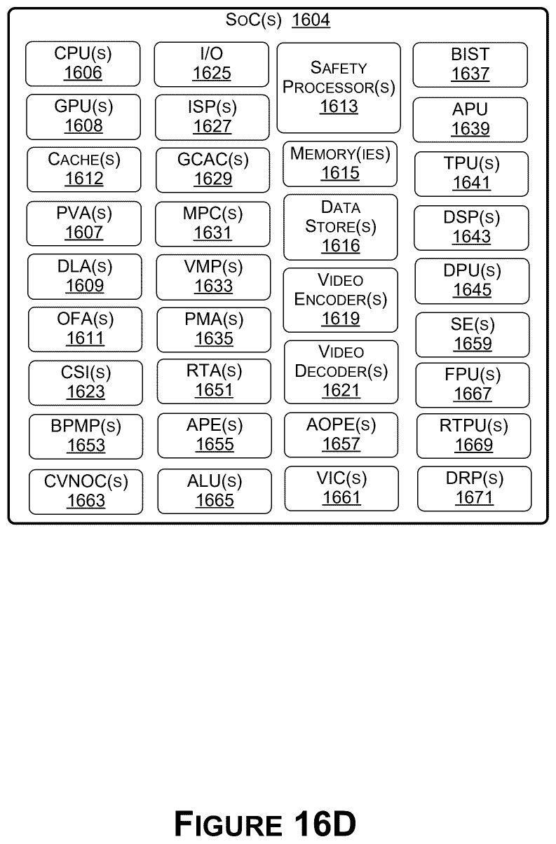

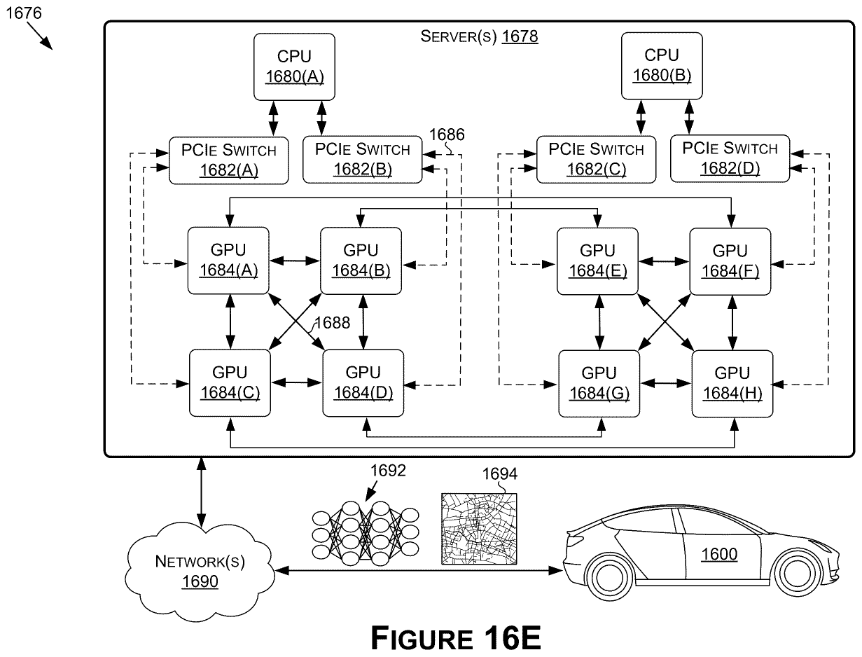

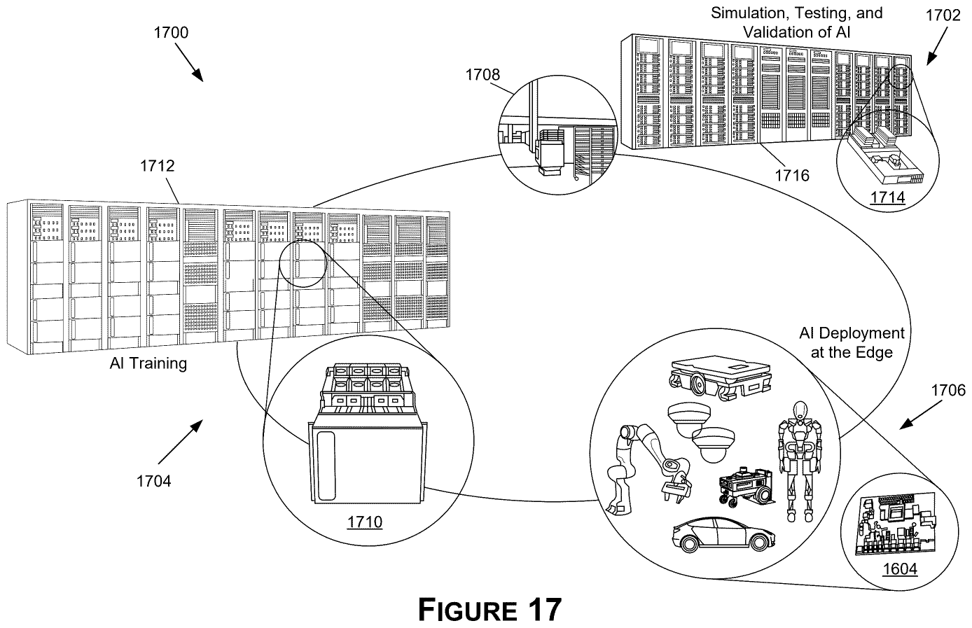

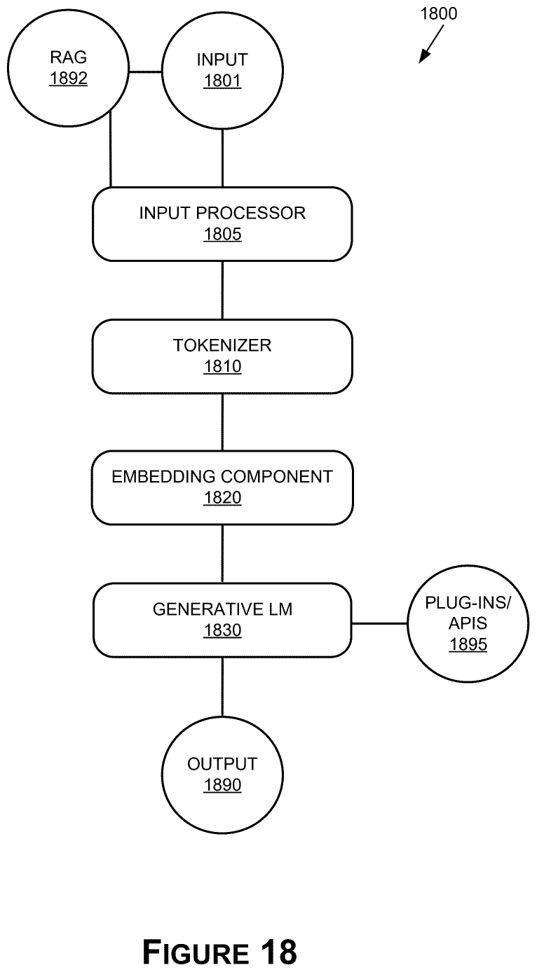

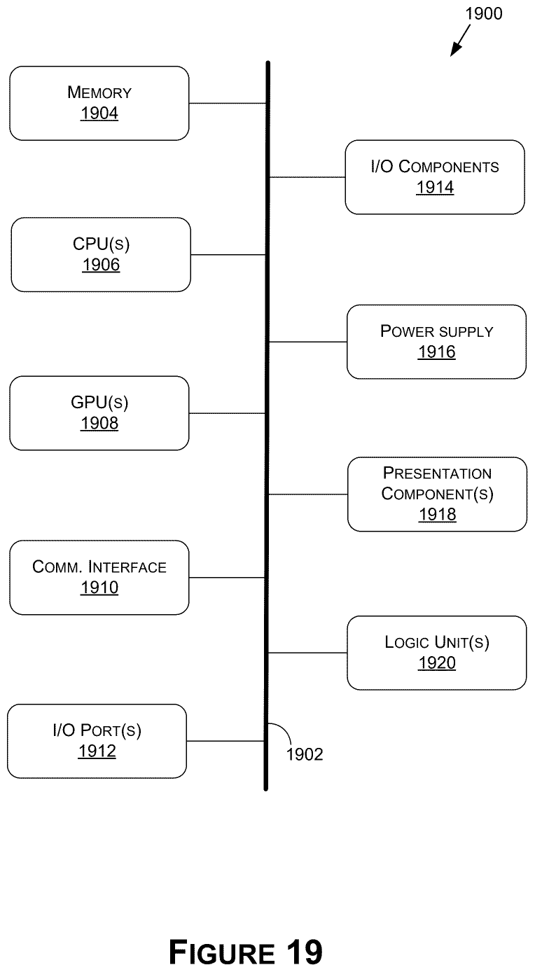

Systems and methods are disclosed related to generation of waypoint graphs for autonomous or semi-autonomous systems and applications. Although the present disclosure may be described with respect to an example autonomous or semi-autonomous vehicle, robot, and/or other machine type 1600 (alternatively referred to herein as “vehicle 1600,” “ego-vehicle 1600,” “machine 1600,” “ego-machine 1600,” “robot 1600,” and/or “ego-robot 1600,” an example of which is described with respect to FIGS. 16A-16E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to generating waypoint graphs for autonomous or semi-autonomous navigation, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where waypoint graph-based navigation may be used. In some embodiments, the systems, methods, and/or processes described herein may be executed using similar components, features, and/or functionality to those of example machine 1600 of FIGS. 16A-16E, example computing ecosystem 1700 of FIG. 17, example generative language model system 1800 of FIG. 18, and/or example computing device 1900 of FIG. 19.

For instance, a system(s) may obtain data representing an occupancy map (e.g., an occupancy grid map, a per-pixel occupancy map or image, or generally occupancy information) associated with an environment. This data may, in some instances, include or be derived from image data representing an image (e.g., a 2D image) that visually depicts the occupancy map. The occupancy map may indicate occupied areas in the environment, such as areas where objects or other obstacles are located, as well as unoccupied areas in the environment, such as areas of free-space through which a machine (e.g., an autonomous or semi-autonomous robot or vehicle) may navigate. In various examples, the occupancy map may be generated based on sensor data, such as LiDAR, RADAR, stereo camera input, and/or pre-existing blueprints, and may be static or may be updated in real time depending on changes in the environment.

In some instances, the system(s) may generate a distance map associated with the environment based on the occupancy map. For instance, the system(s) may compute a distance transform of the free-space in the occupancy map to generate the distance map. The distance transform may calculate, for each location in the free-space, a value corresponding to the shortest distance to the nearest occupied area. The distance map may be depicted in an image that is represented using image data, where one or more points (e.g., pixels or groups of pixels) in the image correspond to one or more locations in the environment. In such instances, one or more (e.g., each) of the point(s) in the image may be assigned values indicating one or more distances of the point(s) (e.g., each point) to the closest occupied area of the environment. In other words, each point's (or pixel's) value in the image of the distance map may represent that point's distance to the closest obstacle in the environment. In some cases, the distance transform may be computed across the entire occupancy map or within selected regions, depending on computational constraints and the required level of spatial resolution.

In some examples, the system(s) may generate a binary map based on the distance map. For instance, the system(s) may convert the distance map into the binary map by applying a safety threshold. This binary map may serve to distinguish traversable areas from non-traversable areas by effectively expanding the occupied regions to include a buffer zone around obstacles. By converting the distance map into the binary map, the system(s) may effectively increase sizes of the occupied areas by adding a safety buffer or perimeter around the occupied areas. For example, points in the distance map that have a value (e.g., a distance to the nearest obstacle) below the safety threshold may be marked as non-traversable, while points with a value above the threshold may be considered safe for navigation. In this way, the system(s) may refrain from placing waypoint graph nodes and/or edges too close to an obstacle. The binary map may subsequently be used to constrain where nodes are placed and to limit which edges are considered valid during waypoint graph construction. In some examples, the safety threshold may be a constant value across the entire map or may vary spatially between regions of the map/environment (e.g., regions with dangerous obstacles may have a greater safety threshold, while regions with less dangers obstacles may have a lower safety threshold).

Using one or more of these data sources (e.g., the occupancy map, the distance map, and/or the binary map), the system(s) may strategically determine locations for nodes of a waypoint graph. As described herein, the system(s) may iteratively add nodes to the waypoint graph in a manner that seeks to achieve sufficient coverage of the traversable areas of the environment, as indicated by the occupancy-related maps. For instance, the system(s) may generate a skeleton image of the binary map and identify one or more branches on the skeleton. The system(s) may add, or otherwise position, nodes of the waypoint graph at endpoints of the skeleton branches, trace the branches to identify long segments, add one or more intermediate nodes along those segments, and/or connect the nodes along the branches. Additionally, or alternatively, the system(s) may detect contours (also referred to herein as “perimeters”) of obstacles and represent them as polygons. For one or more (e.g., each) of the obstacle contours, the system(s) may create nodes at the vertices, trace the contours and add intermediate nodes along long edges, and/or connect the nodes along the contours. These initial node placements may reflect key structural and topological features of the environment and serve as a foundation for subsequent construction and optimization of the waypoint graph.

In some examples, the system(s) may further refine the waypoint graph by identifying areas of low coverage within the traversable space. For instance, the system(s) may compute a distance transform of the safety-thresholded free-space with respect to the current or existing set of nodes and obstacles of the waypoint graph. This transform may indicate, for one or more (e.g., each) points in the free-space, the distance to the nearest existing node or obstacle. Based on the resulting distance map, the system(s) may identify local maxima (e.g., points that are farther from existing nodes than their surrounding neighbors) and add nodes at locations corresponding to the local maxima where the distance exceeds a specified threshold. In other words, the system(s) may prioritize adding new nodes in regions of the environment that are furthest from the current structure of the graph, thereby improving spatial coverage and minimizing areas where navigation paths might otherwise require excessive detours or lack connectivity. Additionally, by adding the nodes at the locations where the distance exceeds the specified threshold, the system(s) may prevent nodes from being placed too close to one another, thereby avoiding overcrowding and promoting a more uniform and efficient distribution of nodes across the traversable space.

As described herein, in various examples, the system(s) may iteratively repeat this process until nodes are evenly placed and distributed across the waypoint graph. For instance, after one or more (e.g., each) rounds of node additions, the distance transform may be recomputed, and additional nodes may be added at any newly identified local maxima that satisfy the distance condition. In this way, the system(s) may incrementally improve the spatial coverage of the waypoint graph while maintaining minimum separation between nodes, thereby ensuring that traversable areas of the environment remain within a desired proximity to at least one node of the waypoint graph and minimizing unnecessary redundancy or clustering.

In some instances, the system(s) may generate edges of the waypoint graph by establishing connections between one or more pairs of nodes based on geometric relationships. For instance, the system(s) may apply one or more techniques—such as Delaunay triangulation—to determine candidate connections between nodes. In the case of Delaunay triangulation, the system(s) may generate a set of triangles that define proximity-based groupings of one or more (e.g., three) nodes of the waypoint graph. For one or more (e.g., each) triangles, the system(s) may connect the corresponding nodes with edges, subject to collision checks and applicable safety thresholds. In additional or alternative examples, the system(s) may apply one or more other geometric or spatial strategies to identify node pairs for connection, such as connecting nearest neighbors within a distance threshold, evaluating line-of-sight visibility, and/or using other spatial heuristics. In this way, the system(s) may construct a graph by adding edges that reflect the structure of the environment and support efficient and safe path planning across the traversable space.

In some examples, the system(s) may optimize (e.g., update, refine, etc.) the waypoint graph by pruning redundant or non-contributing elements from the graph structure. For instance, the system(s) may identify and remove isolated nodes (e.g., nodes that are not connected to any other node by an edge). Additionally, or alternatively, the system(s) may detect and remove small, connected subgraphs that do not form meaningful paths through the environment, such as clusters of nodes that are disconnected from the larger graph or are confined to narrow, unreachable areas. Additionally, or alternatively, the system(s) may identify clusters of nodes that are positioned in close proximity to one another and merge those nodes into a single representative node while maintaining connections with neighboring nodes. That is, the system(s) may analyze connectivity patterns and spatial relationships to determine whether multiple nearby nodes may be substituted with a single node without degrading graph performance or navigability. In various instances, one or more of these optimizations may be performed to reduce complexity, improve runtime efficiency, and/or yield a waypoint graph that is both compact and effective for use in navigation and path planning.

In various embodiments, the system(s) may send the waypoint graph (e.g., optimized waypoint graph) to one or more autonomous or semi-autonomous machines for use in navigation, planning, control, and/or coordination tasks. For instance, the waypoint graph may be provided to an autonomous mobile robot (AMR), robotic vehicle, and/or humanoid robot operating within the environment. The waypoint graph may serve as a global planning structure, enabling the machine(s) to determine high-level paths from a start location to a destination location by traversing connected nodes along the edges while avoiding obstacles and respecting safety constraints. In some implementations, the waypoint graph may be used in conjunction with lower-level controllers or local planners that translate high-level paths into executable motion commands, allowing the machine(s) to dynamically respond to local variations or unmodeled obstacles while still adhering to the planned route. In various instances, the waypoint graph may be shared among multiple machines in a fleet or coordinated system to facilitate multi-agent scheduling, collision avoidance, or cooperative task execution. In such cases, a centralized or distributed planner may use the waypoint graph to assign routes, resolve conflicts, and optimize travel across the shared environment.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine sparse waypoint graphs from simulated occupancy grid maps, perform coverage evaluation and optimization, and validate navigation and scheduling behavior in structured and unstructured environments (e.g., warehouses, offices, or other facilities), etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., occupancy maps, skeletonized map structures, contour representations, distance transforms, waypoint graph node placements, and edge connectivity outcomes from within the simulation. The synthetic training data (in addition to or alternatively from real-world data) may then be used or processed to train planning systems or machine learning models that predict optimal graph construction parameters, assess dynamic reconfiguration strategies, or support simulation-to-reality transfer of navigation policies.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to generate and display sparse waypoint graphs overlaid on occupancy grid maps, highlighting feasible paths, coverage areas, obstacle contours, and optimal navigation routes that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the systems and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, occupancy grid maps, waypoint graphs, and one or more machine learning models). The robotic system may use these processors to execute graph generation, optimization, and navigation routines based on the sparse waypoint graphs generated from occupancy maps, as described herein. These waypoint graphs may enable the robot to perform path planning and navigation tasks in structured or unstructured environments by leveraging strategically placed nodes and collision-free edges that reflect both free-space topology and obstacle contours. The robot may acquire environment data through onboard sensors such as cameras, LiDAR, RADAR, or ultrasonic sensors, and may apply sensor fusion techniques to build or update occupancy maps of its surroundings. These maps may then be used to generate or update sparse waypoint graphs in real time or periodically, enabling the robot to compute efficient paths from a current location to a target location. In some implementations, the processing of graph construction or optimization may be performed locally or offloaded to a remote server depending on computational load. In multi-robot scenarios, data from individual robots (e.g., current positions, task assignments, and local maps) may be shared with a centralized planner or cloud-based orchestration system, which may generate a shared waypoint graph or coordinate route assignments using the graph structure. In some embodiments, machine learning model(s) (e.g., deep neural networks, vision-language models, or reinforcement learning agents) may be used to predict graph parameters, assess node utility, or inform edge pruning decisions. In addition, the robotic system may communicate (e.g., using one or more network interface cards (NICs) and/or data processing units (DPUs)) with one or more locally hosted servers/computing devices and/or remotely located servers/computing devices (e.g., in one or more data centers) to facilitate collaborative planning, map synchronization, or distributed execution of tasks based on the generated waypoint graphs.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment and execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). In some embodiments, the machine learning model(s) may support tasks related to waypoint graph construction, such as predicting optimal graph parameters (e.g., node spacing, threshold distances), identifying sparse node placement patterns based on map topology, or learning-based heuristics for graph pruning or edge selection. The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, or graph-related map data), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

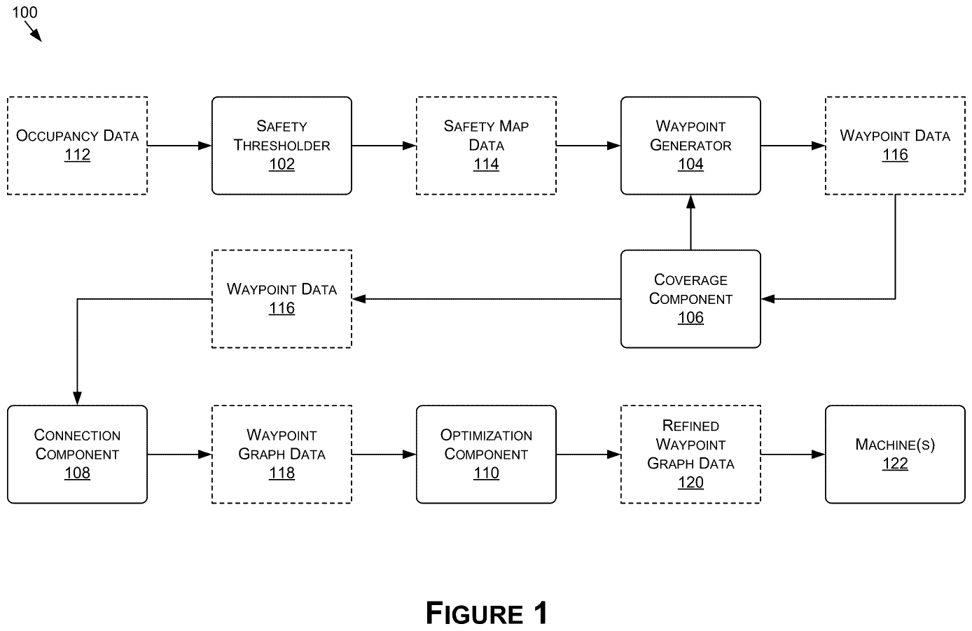

With reference to FIG. 1, FIG. 1 is a data flow diagram illustrating an example of a process 100 that may be performed by a system to generate sparse waypoint graphs from occupancy grid maps, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located -such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1600 of FIGS. 16A-16E, example computing ecosystem 1700 of FIG. 17, example generative language model system 1800 of FIG. 18, and/or example computing device 1900 of FIG. 19.

As shown, the process 100 may be implemented using, amongst additional or alternative components, a safety thresholder 102, a waypoint generator 104, a coverage component 106, a connection component 108, and an optimization component 110. As a brief overview, the process 100 may begin by the safety thresholder 102 receiving occupancy data 112 representing an occupancy map of the environment. The safety thresholder 102 may use the occupancy data 112 to generate safety map data 114. The waypoint generator 104 may then use the safety map data 114 to generate waypoint data 116 representing one or more nodes of a waypoint graph. The coverage component 106 may evaluate the waypoint data 116 to determine if the waypoint graph includes adequate coverage. If distances between the nodes of the waypoint graph are too great (e.g., the graph does not include adequate coverage), the process 100 may proceed back to the waypoint generator 104 to generate additional waypoint data 116 (e.g., nodes), otherwise the waypoint data 116 may be forwarded to the connection component 108. The connection component 108 may establish connections between the nodes of the waypoint graph to generate edges, and output the resulting waypoint graph which may be represented using the waypoint graph data 118. The optimization component may optimize the waypoint graph and generate refined waypoint graph data 120 representing the optimized (e.g., updated, refined, etc.) waypoint graph. The refined waypoint graph data 120 may then be sent to one or more machines 122, which may use the waypoint graph to plan routes through an environment.

As described above and herein, the occupancy data 112 may represent an occupancy map (e.g., an occupancy grid map) of an environment. In some examples, the occupancy data 112 may include image data representing an image depicting a visualization of the occupancy map. For instance, the occupancy map may be treated as image data, such as a two-dimensional (2D) grayscale or binary image, in which each pixel corresponds to a spatial location in the environment and encodes whether that location is free, occupied, or unknown. That is, pixel values may be used to indicate obstacle presence or absence, with different intensity levels or binary encodings representing occupied and unoccupied regions. This image-based representation may be derived from sensor data, such as LiDAR, stereo cameras, or pre-constructed environmental models, and may, in some instances, be updated in real time to reflect dynamic changes in the environment.

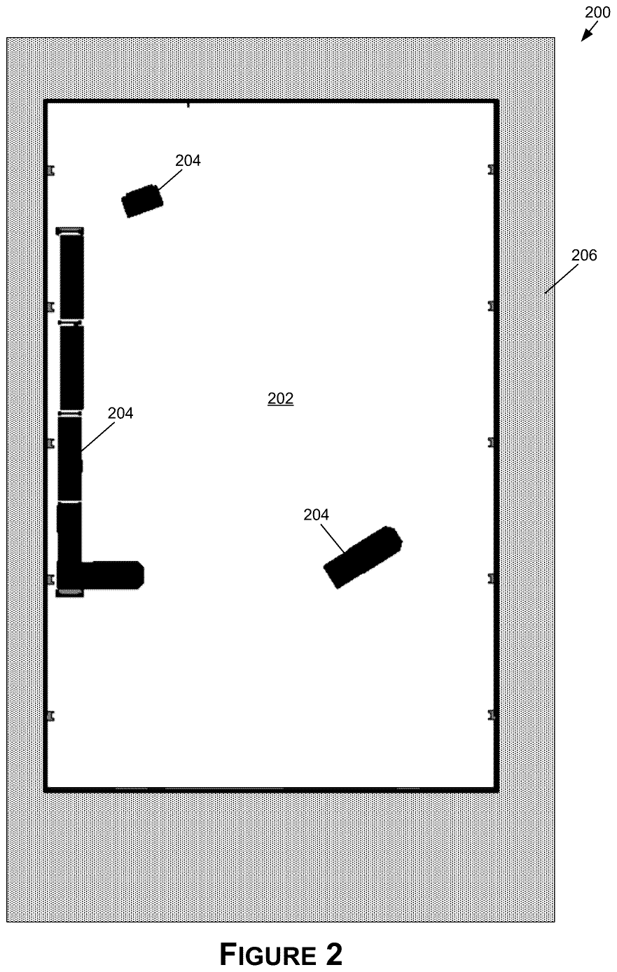

For instance, FIG. 2 illustrates an example of an occupancy grid map 200 associated with an environment, in accordance with some embodiments of the present disclosure. As shown, the occupancy grid map 200 may be treated as a two-dimensional image in which different regions are encoded using pixel values that represent different occupancy states. For example, each pixel in the image may correspond to a discrete spatial location in the environment, and its value may indicate whether that location is free, occupied, or unknown. In the example of FIG. 2, the white region 202 may correspond to free-space (e.g., pixels with values representing low or zero occupancy likelihood), black regions 204 may represent obstacles or occupied space (e.g., pixels with values indicating a high likelihood of occupancy), and the shaded or stippled region 206 may denote unknown areas of the environment (e.g., pixels assigned special or default values indicating that no occupancy data is available). These unknown areas may result from occlusions, limited sensor range, or regions that have not yet been explored by the robot. The occupancy grid map 200, which may be represented by—or correspond to—the occupancy data 112, may provide the foundation for subsequent image-based processing steps, such as distance transforms, safety thresholding, skeletonization, and sparse waypoint graph construction.

Referring back to the example of FIG. 1, the process 100 may include the safety thresholder 102 using the occupancy data 112 to generate the safety map data 114. In some examples, the safety map data 114 may represent a binary map of the environment based on the occupancy map. To generate the binary map, the safety thresholder 102 may compute a distance transform over the free-space of the occupancy map. This distance transform may assign, to one or more (e.g., each) pixels representing traversable space, a value corresponding to the shortest distance to the nearest obstacle or occupied pixel. The safety thresholder 102 may compare one or more (e.g., each) of these distance values against a predefined safety threshold. Pixels with a distance value greater than or equal to the threshold may be marked as traversable (e.g., assigned a value of 1), while pixels with a distance value below the threshold—or that correspond to already occupied or unknown space—may be marked as non-traversable (e.g., assigned a value of 0). This thresholding operation may effectively expand obstacle boundaries by a configurable buffer zone, ensuring that generated paths maintain a minimum clearance from obstacles.

As with the occupancy map, in some examples, the safety map data 114 may include image data representing a visualization of the resulting binary map, where regions with pixels of a first value (e.g., white) correspond to safe, traversable areas and regions with pixels of a second value (e.g., black) correspond to unsafe or obstructed areas. In some examples, the safety threshold may be varied across different portions of the map depending on the type or classification of nearby obstacles, structural elements, or operational constraints. For example, a greater safety threshold may be applied near obstacles associated with higher perceived risk—such as narrow passages, machinery, or zones expected to experience human presence—while smaller thresholds may be used in more predictable or tightly bounded regions of the environment. Although the occupancy map may generally represent static features of the environment, the safety thresholder 102 may, in some cases, incorporate additional contextual information or configuration parameters that account for potentially dynamic objects or uncertain areas.

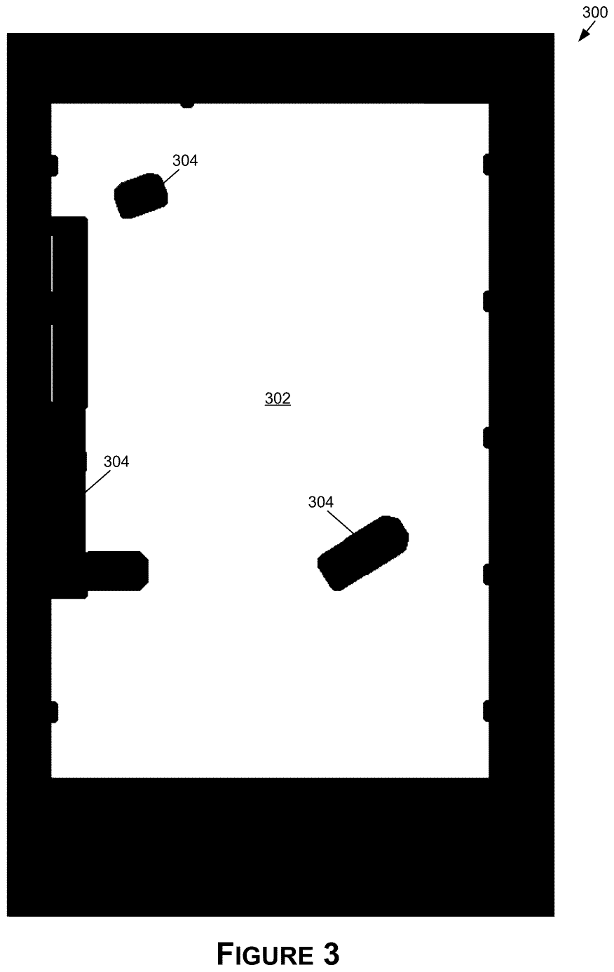

FIG. 3 illustrates an example of an updated version of the occupancy grid map from the example of FIG. 2 based on performing safety-thresholding, in accordance with some embodiments of the present disclosure. In the example of FIG. 3, the updated version of the occupancy grid map represents a binary map 300 (also referred to herein as a “safety-thresholded map”) of the environment, in which the original obstacle boundaries have been expanded based on a predefined safety threshold. The binary map 300 may correspond to, or be represented by, the safety map data 114 from the example of FIG. 1. As shown, the white region 302 may correspond to traversable space—e.g., areas that are a safe distance away from any known obstacle—while the black regions 304 may represent non-traversable space, including both the original obstacles and surrounding buffer zones applied during the thresholding process. The black regions 304 may also encompass formerly free-space areas that fall within the safety clearance zone computed during the distance transform phase. In some embodiments, the binary map 300 may be treated as image data and used as input to subsequent processing stages, such as skeleton generation and contour detection. By expanding obstacle boundaries, the binary map 300 may help ensure that nodes and edges of the waypoint graph are placed within regions that offer sufficient clearance for safe navigation.

Now referring back to the example of FIG. 1, the process 100 may also include the waypoint generator 104 using the safety map data 114 to generate the waypoint data 116, which may represent nodes of or for the waypoint graph. Additionally, the coverage component 106 may evaluate the waypoint data 116 to determine if the nodes adequately cover the navigable space of the occupancy map. If distances between the nodes are too great (e.g., the graph does not include adequate coverage), the process 100 may proceed back to the waypoint generator 104 to update the waypoint data 116 (e.g., add additional nodes). In contrast, if the distances between the nodes are less than a threshold, the waypoint data 116 may be forwarded to the connection component 108.

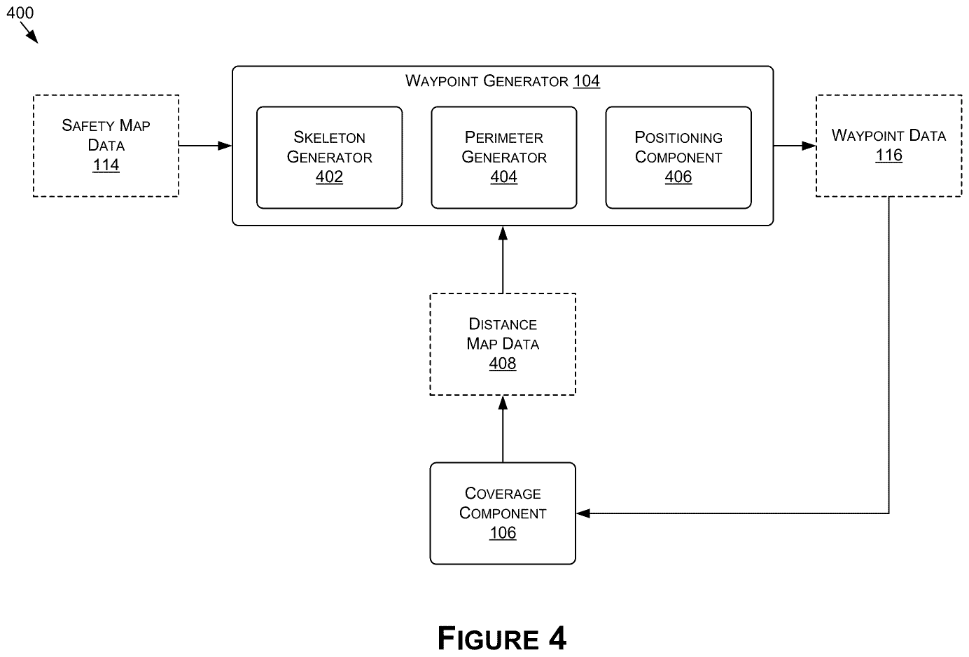

For instance, FIG. 4 illustrates an example of a process 400 for placing nodes of a waypoint graph, in accordance with some embodiments of the present disclosure. As shown, the process 400 may be performed by the waypoint generator 104 using one or more components, including a skeleton generator 402, a perimeter generator 404, and a positioning component 406. The waypoint generator 104 may receive the safety map data 114 as input, which may represent a binary image of the environment indicating traversable and non-traversable regions based on safety-thresholded distance values, as described above and herein. The waypoint generator 104 may use the safety map data 114—along with, in some instances, distance map data 408—to produce waypoint data 116 representing one or more nodes of a waypoint graph. In some examples, the waypoint generator 104 may operate in coordination with the coverage component 106, which may be configured to evaluate whether the current node configuration sufficiently covers the navigable space of the environment.

The skeleton generator 402 may be configured to generate skeleton representations of the free-space encoded in the safety map data 114. For example, the skeleton generator 402 may apply one or more medial axis or thinning algorithms to reduce the traversable space to a simplified set of one-pixel-wide paths or centerlines, referred to as a skeleton. These skeleton paths may correspond to medial zones between obstacles or walls and may reflect common or efficient routes for navigation. The skeleton generator 402 may identify endpoints, branch points, and long continuous segments within the skeleton, and the positioning component 406 may place graph nodes at strategic positions along these features, such as endpoints, junctions, or at fixed intervals along extended branches. By aligning nodes with the topological structure of the environment, the skeleton generator 402 and the positioning component 406 may enable the resulting graph to capture primary navigational corridors with minimal redundancy.

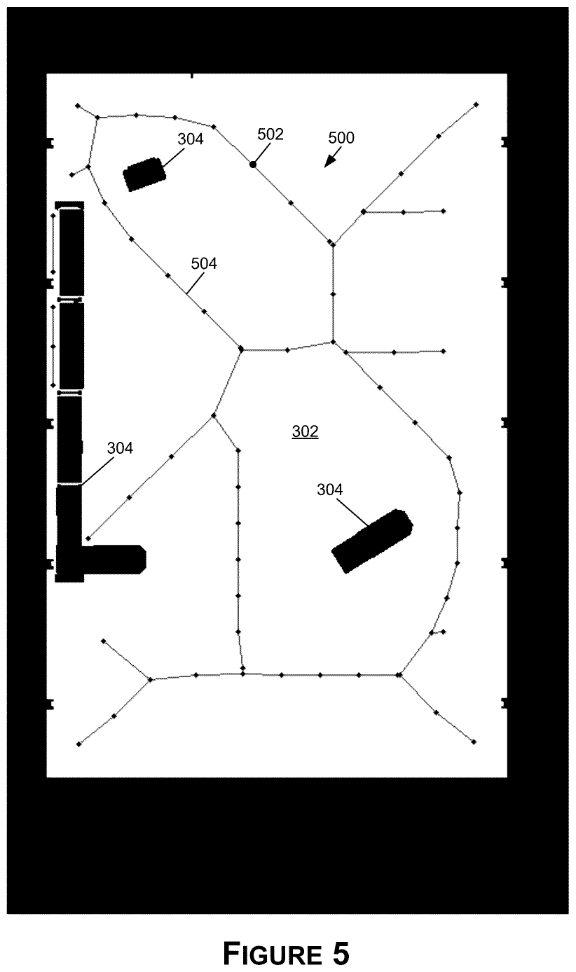

For instance, FIG. 5 illustrates an example of using a topology of a skeleton graph to position nodes and edges of a waypoint graph 500, in accordance with some embodiments of the present disclosure. The skeleton graph may be derived from the safety-thresholded binary map shown in FIG. 3, where traversable space 302 has been identified and obstacle regions 304 have been expanded based on safety margins. The skeleton graph may represent a topological abstraction of the free-space and may be generated by the skeleton generator 402 using one or more medial axis, thinning, or image morphology techniques. These techniques may reduce the traversable regions of the binary map to a simplified structure that traces central corridors between obstacles and walls, providing a basis for strategic node and edge placement within the environment.

As shown in FIG. 5, a plurality of nodes—such as the node 502—and a plurality of edges—such as the edge 504—of the waypoint graph 500 may be strategically positioned to correspond to a topology of the skeleton graph. In some examples, the nodes 502 may be placed at locations such as endpoints of skeleton branches, intersections between multiple branches, and/or intermediate points along extended or continuous skeleton paths. The nodes may reflect structurally significant or spatially balanced positions that support efficient graph coverage and connectivity. The edges may be formed by connecting the nodes along the skeleton structure, thereby following the geometry of the medial paths derived from the traversable space. The resulting node and edge configuration may correspond to the skeleton graph and capture the underlying structure of the environment while maintaining sparsity and navigational utility. The waypoint graph 500 illustrated in the example of FIG. 5 may correspond to, or be represented by, the waypoint data 116.

Referring back to the example of FIG. 4, the perimeter generator 404 may be configured to identify and represent the boundaries of obstacles or other non-traversable regions within the safety map data 114. In some examples, the perimeter generator 404 may extract contours or polygonal outlines that approximate the shapes of detected obstacles based on the binary map. The positioning component 406 of the waypoint generator 104 may then place graph nodes at vertices and/or corners of these perimeter shapes, as well as potentially along longer edges where intermediate points may improve spatial resolution. This perimeter-based node placement may ensure that environmental boundaries are well represented in the waypoint graph, improving path planning performance in constrained environments or near tight obstacle arrangements.

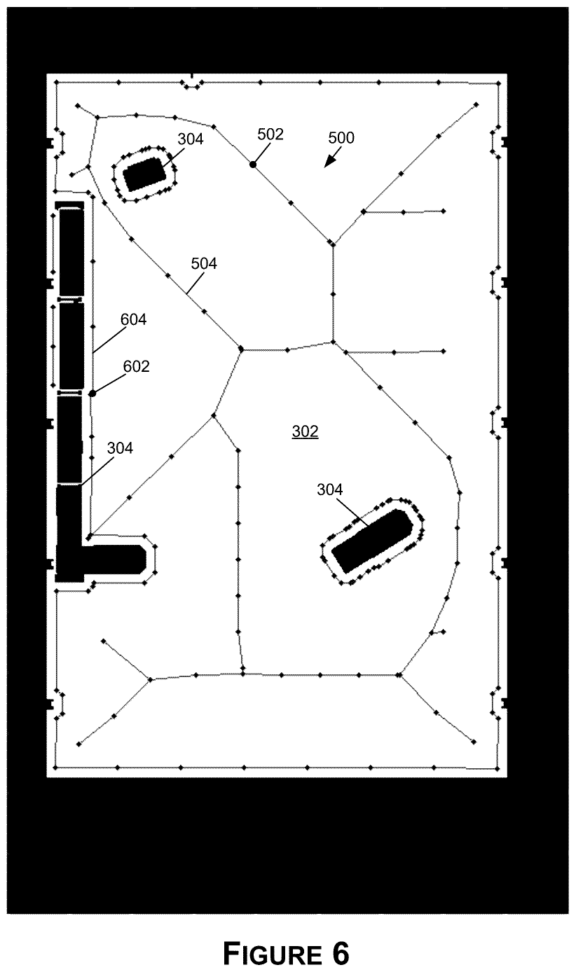

For instance, FIG. 6 illustrates an example in which nodes and edges of the waypoint graph 500 have been added that correspond to safety-thresholded obstacle perimeters in the occupancy grid map, in accordance with some embodiments of the present disclosure. The example of FIG. 6 builds upon the skeleton-based waypoint graph 500 shown in FIG. 5 by adding additional nodes and edges that capture the geometric structure of obstacle boundaries. These boundaries may be derived from the binary safety map data based on the transition between traversable space and non-traversable regions associated with the obstacles. In particular, the obstacle boundaries may be extracted as polygonal contours using one or more edge detection or shape approximation techniques applied to the thresholded map.

In some examples, the perimeter generator 404 may analyze the safety map data 114 to detect these obstacle perimeters and generate corresponding geometric outlines. The positioning component 406 may then place a plurality of graph nodes—such as the node 602—along the resulting perimeter shapes. These nodes may be positioned at corners, curvature points, or uniformly along extended edges of the obstacle boundaries to preserve the spatial features of the environment. As shown, one or more edges—such as the edge 604—may connect adjacent nodes placed along the perimeter, forming localized segments that trace around the obstacle contours. The waypoint graph 500 illustrated in the example of FIG. 6 may correspond to, or be represented by, the waypoint data 116.

Referring back to the example of FIG. 4, the coverage component 106 may be configured to assess whether the nodes represented by the waypoint data 116 provide sufficient spatial coverage of the free-space regions of the environment. For example, the coverage component 106 may compute a distance transform over the traversable space in the safety map data 114 to generate a distance map. The resulting distance map—represented by the distance map data 408—may encode, for one or more (e.g., each) locations in the free-space, a value corresponding to the shortest distance to the nearest node or edge of the waypoint graph, obstacle boundary, or non-traversable region. In some examples, the coverage component 106 may analyze the distance map to identify local maxima (e.g., locations that are farther from existing nodes or obstacles than their surrounding neighbors). These local maxima may serve as candidate positions for placing new graph nodes, particularly in underrepresented or sparse areas of the environment.

In various examples, the coverage component 106 may compare the values at the local maxima to a defined spacing or coverage threshold to determine whether additional nodes should be placed. If local maxima values fall below the threshold, the waypoint graph may be considered sufficiently dense, and the node placement process may be deemed complete. However, if one or more local maxima exceed the defined threshold, this may indicate that the waypoint graph lacks adequate coverage. In such cases, the distance map data 408 may be provided to the waypoint generator 104, and the positioning component 406 may use the distance map data 408 to place additional nodes at the locations of the high-valued local maxima. These nodes may be added to the waypoint graph and output as updated waypoint data 116. The updated waypoint data 116 may then be re-evaluated by the coverage component 106 to determine whether further additions are necessary.

In various examples, this process may be repeated in an iterative feedback loop, where the coverage component 106 and the waypoint generator 104 work in coordination to refine the waypoint graph. With each iteration, the graph may grow by incorporating new nodes at under-covered locations, leading to a progressively more uniform and sparse distribution of nodes throughout the navigable space. By continuing this process until no local maxima exceed the threshold, the system(s) may ensure that all regions of the free-space are within a desired proximity to at least one graph node, while avoiding over-clustering and maintaining computational simplicity.

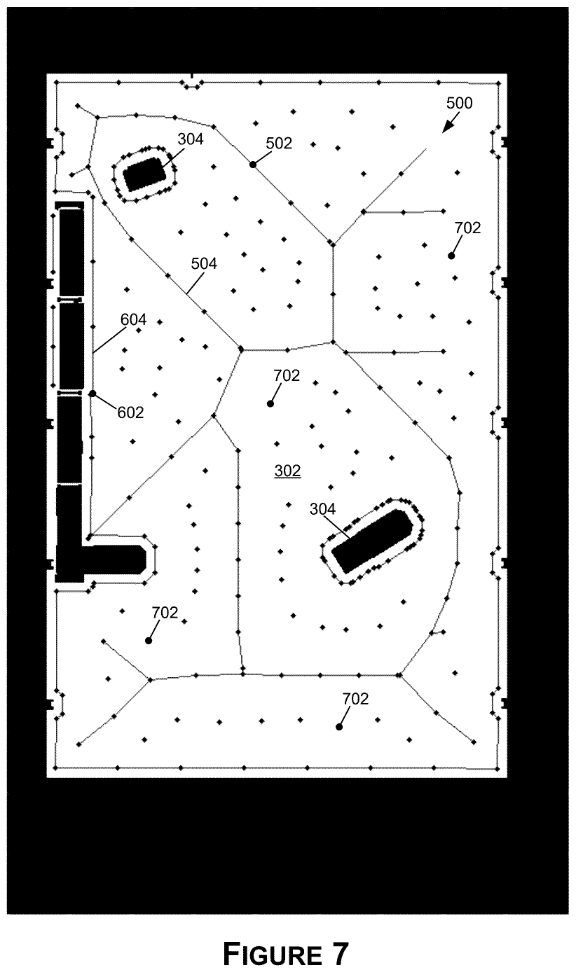

For instance, FIG. 7 illustrates an example of the waypoint graph 500 in which nodes 702 have been added to correspond to points in free-space areas of the occupancy grid map, in accordance with some embodiments of the present disclosure. As shown, the nodes 702 may be positioned in regions that are not already represented by nodes aligned with skeleton paths, obstacle perimeters (e.g., nodes 602 from FIG. 6), or other structural features. In some examples, the nodes 702 may correspond to additional nodes placed at one or more (e.g., each) local maxima locations identified within a distance map computed using the coverage component 106. These local maxima may represent points in the traversable space that are farther from existing graph elements—such as nodes, edges, or obstacles—than one or more (e.g., each) of their neighboring points.

In some examples, the positioning component 406 may add one or more of the nodes 702 at locations where the value at the local maximum exceeds a predefined spacing or coverage threshold. This node placement process may supplement existing node placements by increasing coverage in interior or underrepresented regions of the environment. As illustrated in FIG. 7, this may result in a more uniform distribution of nodes throughout the traversable space, potentially improving overall graph connectivity and planning reliability. The coverage component 106 may then re-analyze the updated waypoint graph 500 to assess whether any remaining local maxima continue to exceed the threshold. If so, additional iterations may be performed to add further nodes until identified maxima fall below the coverage threshold. When this condition is met, the node placement process may be considered complete, resulting in a waypoint graph 500 that offers broad navigational reach without unnecessary node redundancy.

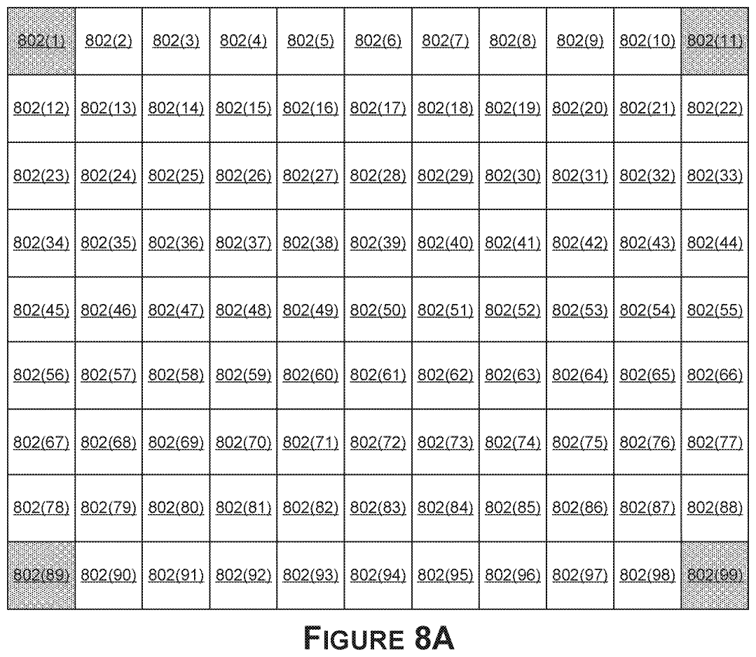

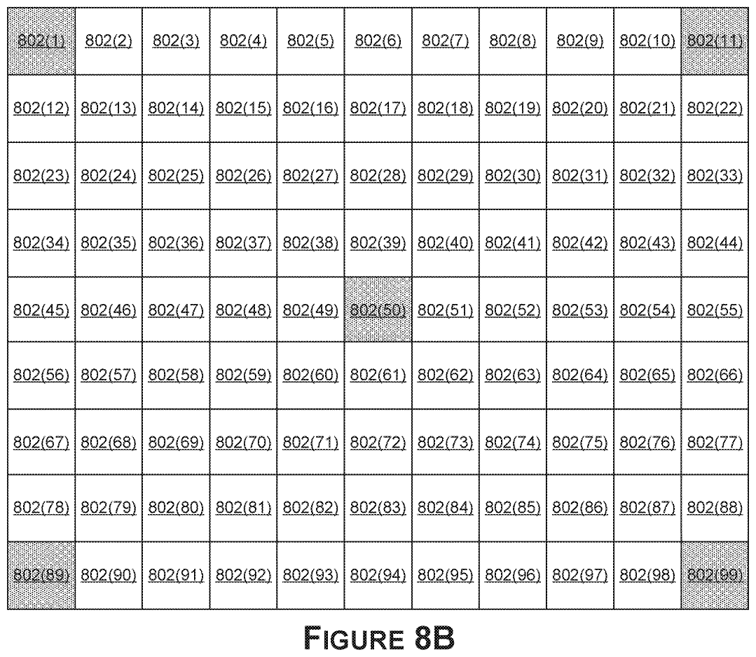

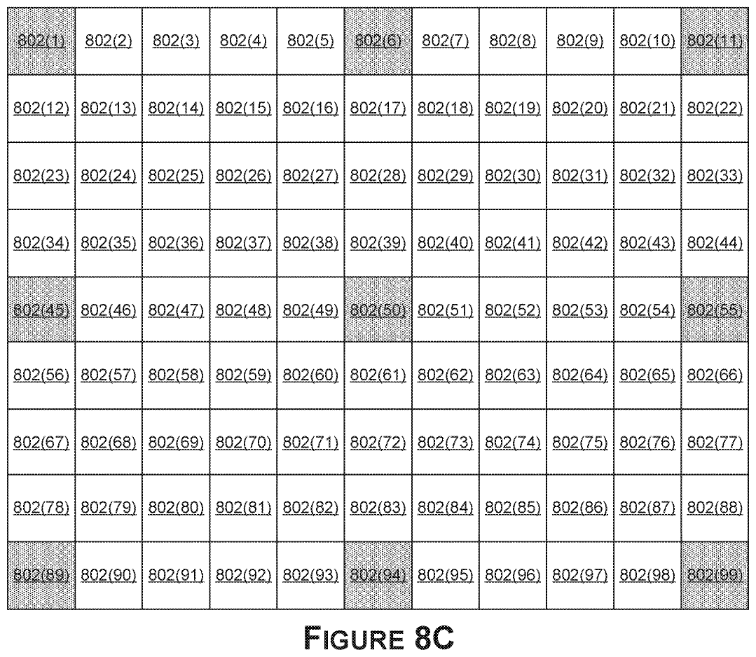

As another example, FIGS. 8A-8C collectively illustrate an example of adding waypoint graph nodes at locations corresponding to local maxima points that are a threshold distance away from existing nodes, in accordance with some embodiments of the present disclosure. The illustrated figures depict a simplified grid of spatial locations 802(1)-802(99), which may correspond to points or pixels of traversable positions in an environment or a region of the safety map data 114. In these examples, the shaded points indicate locations where nodes of a waypoint graph are positioned, while the unshaded points represent candidate positions for future node placement.

In FIG. 8A, nodes of the waypoint graph have been initially placed at locations 802(1), 802(10), 802(89), and 802(99). These nodes may represent an initial set of placements, either manually selected or automatically derived using other components (e.g., the skeleton generator 402 or perimeter generator 404). As described herein, in some examples, a distance transform may be computed to identify distances between each traversable location and the nearest existing node. The result may be a distance map used to identify local maxima—points that are further from the nearest node than their surrounding neighbors.

As shown in FIG. 8B, a local maximum may be detected at location 802(50), which is the furthest location away from the initial locations 802(1), 802(10), 802(89), and 802(99) of the existing nodes in FIG. 8A. Because the distance at this local maximum exceeds a defined coverage threshold (e.g., 3 points or pixels), the coverage component 106 may determine that the waypoint graph lacks sufficient coverage, and the waypoint generator 104 may place a new node at the location 802(50). The updated node set may then be passed back to the coverage component 106 to re-evaluate spatial coverage across the region.

In FIG. 8C, the process is repeated, and additional local maxima—now the farthest uncovered points given the existing nodes—are identified and used as new node locations 802(6), 802(45), 802(65), and 802(94). These new nodes may be added by the waypoint generator 104 and may contribute to improved spatial uniformity. This iterative procedure may continue until the values at all remaining local maxima fall below the threshold, thereby indicating that the graph provides sufficient spatial coverage across the traversable region.

Referring back now to the example of FIG. 1, the process 100 may include the waypoint data 116 being forwarded to the connection component 108. The waypoint data 116 may represent locations of one or more (e.g., each) of the nodes that have been strategically placed throughout the environment based on one or more prior operations—such as skeleton generation, perimeter detection, and/or local maxima placement. The connection component 108 may use this data to establish connectivity between nodes by generating edges that link selected pairs of nodes. These edges may define traversable paths that form the structure of the waypoint graph and enable downstream path planning and routing algorithms to compute navigation strategies through the environment.

In some examples, the connection component 108 may apply one or more geometric graph generation models to determine which node pairs to connect. The geometric graph generation model(s) may include an algorithmic approach that creates connections between nodes based on spatial or geometric relationships. For instance, the connection component 108 may evaluate Euclidean distances between node pairs and connect nearby nodes that lie within a certain distance threshold, optionally subject to line-of-sight visibility or obstacle checks. Additionally, or alternatively, the connection component 108 may apply proximity-based triangulation methods—such as Delaunay triangulation or variants thereof—which may create edges between nodes that are part of non-overlapping triangles satisfying certain geometric properties (e.g., the Delaunay condition, which avoids narrow angles). These geometric approaches may, in some examples, be used alone or in combination with spatial heuristics or collision-checking routines to ensure that generated edges do not intersect obstacles or violate safety constraints encoded in the underlying occupancy or safety maps.

In some embodiments, the connection component 108 may also evaluate traversability criteria or apply safety margins when generating edges, such as refraining from creating connections that pass too close to obstacles, walls, or restricted regions. The result may be a graph that includes collision-free and safety-compliant connections, improving reliability for downstream planning operations. Once the edges are generated, the connection component 108 may combine them with the corresponding node data and output waypoint graph data 118 representing the resultant waypoint graph.

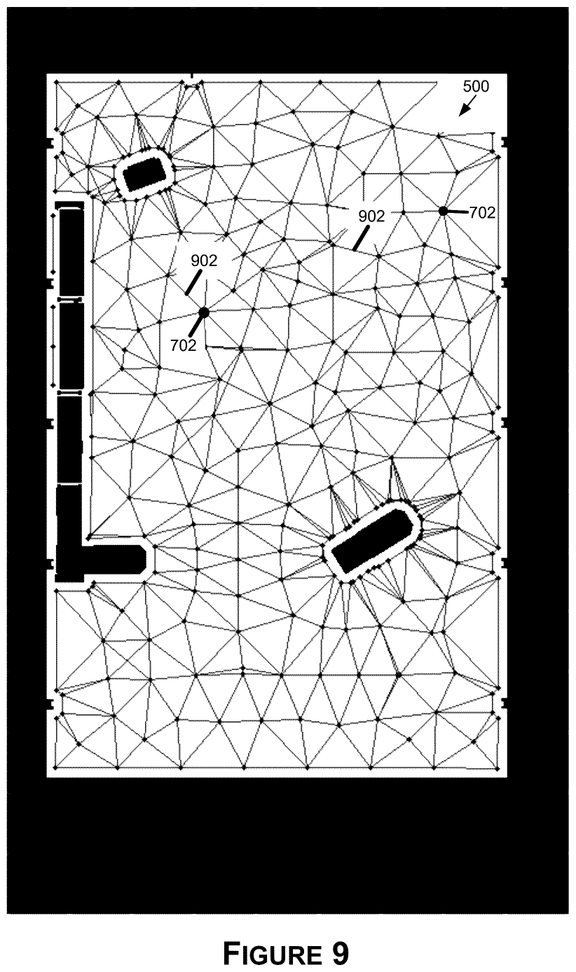

For instance, FIG. 9 illustrates an example of the waypoint graph 500 in which connections have been made between the nodes 702 to create edges 902, in accordance with some embodiments of the present disclosure. As shown, the nodes 702—such as those previously placed based on skeleton structures, obstacle perimeters, and local maxima within the free-space—have been connected using a geometric graph generation model. These connections may form the edges 902 that define navigable paths between pairs of nodes while maintaining spatial efficiency and obstacle avoidance.

In some examples, the geometric graph generation model used to generate the edges 902 may incorporate proximity-based rules, such as connecting nodes that are within a certain distance threshold, or spatial triangulation techniques that evaluate node configurations and form connections based on geometric constraints. For example, as illustrated in FIG. 9, the resulting network of edges 902 may resemble a triangulated structure that captures the spatial relationships between nearby nodes 702 while avoiding connections that intersect non-traversable regions (e.g., obstacle boundaries or other regions associated with the safety map). This structure may reflect an efficient and sparse representation of the traversable space, suitable for use in global planning algorithms.

Referring back to the example of FIG. 1, the process 100 may also include the optimization component 110 optimizing the waypoint graph to generate an updated and/or improved version of the waypoint graph, which may be represented by the refined waypoint graph data 120. In some examples, the optimization component 110 may analyze the structure of the graph to identify redundant, isolated, or non-contributing elements—such as nodes that are disconnected from the rest of the graph, edges that contribute minimal navigational value, or clusters of densely positioned nodes that could be merged without compromising coverage. Based on this analysis, the optimization component 110 may perform one or more refinement operations, including node pruning, edge removal, subgraph elimination, or node merging.

For instance, the optimization component 110 may evaluate the degree of connectivity of one or more nodes and remove nodes that are not part of any meaningful path through the environment. Similarly, small, disconnected subgraphs may be removed if they are unlikely to serve a navigational purpose. In regions where multiple nodes are located in close proximity to one another—e.g., within a minimum separation threshold—the optimization component 110 may replace them with a single representative node while maintaining or restoring connectivity with the surrounding graph. These and other operations may be applied in a way that preserves or enhances the navigability of the graph while reducing unnecessary complexity, promoting runtime efficiency, and improving the interpretability of the resulting structure.

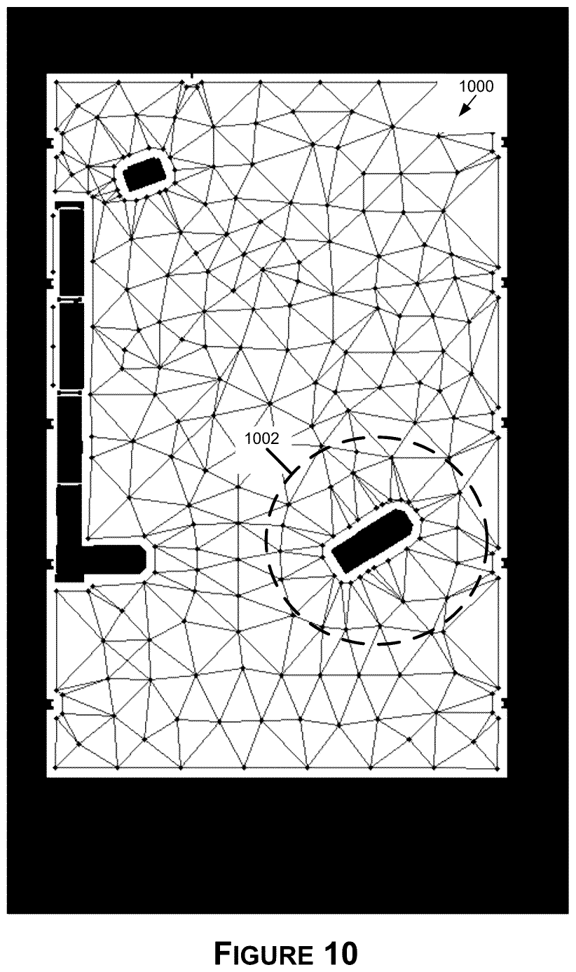

For instance, FIG. 10 illustrates an example of an optimized version of the waypoint graph 1000 in which one or more nodes or edges have been strategically removed, in accordance with some embodiments of the present disclosure. For instance, the optimized version of the waypoint graph 1000 includes a region 1002 in which a plurality of nodes and edges of the graph have been simplified as compared to the graph 500 depicted in the example of FIG. 9.

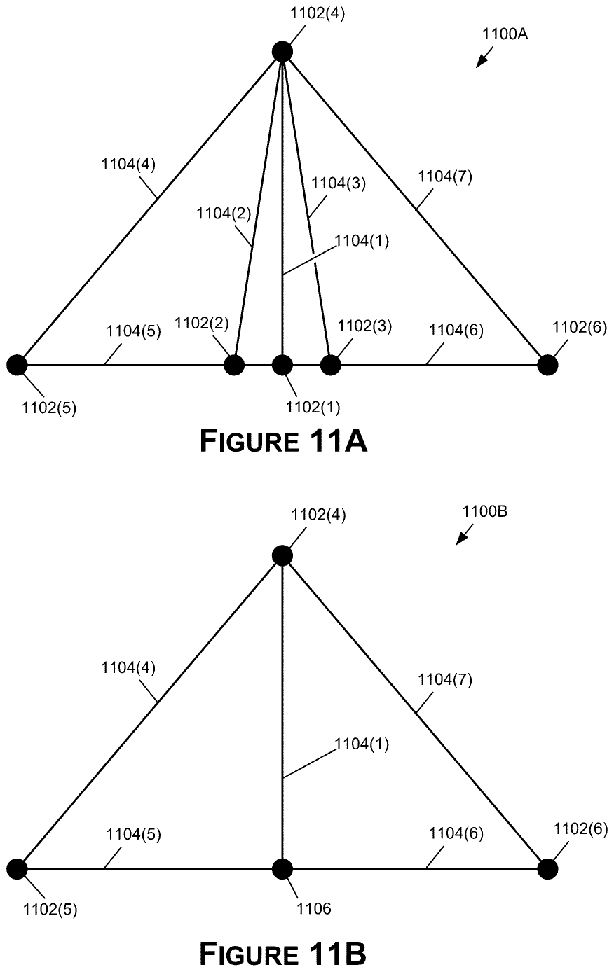

As another example, FIGS. 11A and 11B collectively illustrate an example of optimizing a portion of a waypoint graph by merging densely clustered nodes, in accordance with some embodiments of the present disclosure. Referring first to FIG. 11A, a first version 1100A of the waypoint graph portion is illustrated including a plurality of nodes 1102(1)-1102(6) and a plurality of edges 1104(1)-1104(8). In some examples, the optimization component 110 may evaluate spatial relationships between nearby nodes and determine that nodes 1102(1), 1102(2), and 1102(3) are positioned within a defined minimum spacing threshold. Based on this determination, the optimization component 110 may merge the nodes 1102(1)-1102(3) into a single representative node 1106, as shown in the updated version 1100B of the waypoint graph in FIG. 11B.

The updated version 1100B of the waypoint graph may preserve the functional connectivity of the first version 1100A of the waypoint graph while reducing unnecessary node density and simplifying the overall topology. As shown in FIG. 11B, the representative node 1106 maintains connections with the remaining surrounding nodes—such as node 1102(4), node 1102(5), and node 1102(6)—via updated edges 1104(1), 1104(5), and 1104(6), respectively. This refinement may improve runtime performance during search or planning operations while preserving reachability and spatial fidelity in the graph. Additionally, merging densely clustered nodes may help prevent overfitting to fine-grained map features and reduce noise introduced by redundant or minimally separated nodes. In some examples, the optimization component 110 may perform such node merging procedures as part of a broader graph simplification routine, optionally in conjunction with node pruning, subgraph trimming, or edge reconfiguration to improve graph clarity and maintain navigational robustness.

Referring back to the example of FIG. 1, the process 100 may also include the refined waypoint graph data 120 being sent to the machine(s) 122. In various examples, the machine(s) 122 may use the refined waypoint graph data 120 to plan a route through an environment. For instance, the machine(s) 122 may include one or more autonomous or semi-autonomous robots, vehicles, or other platforms configured to navigate within structured or unstructured spaces. In some examples, the machine(s) 122 may access the refined waypoint graph data 120 to compute navigation paths by selecting and traversing a sequence of connected nodes and edges in the graph that lead from a current location to a destination location.

In some instances, the refined waypoint graph may serve as a global planning framework that supports high-level decision-making and route generation. For instance, the graph may encode safe, traversable regions while excluding paths that approach obstacles or fall within restricted zones. The machine(s) 122 may apply pathfinding algorithms—such as A*, Dijkstra's algorithm, or heuristic search strategies—over the refined waypoint graph to determine optimal or efficient routes. Additionally, the machine(s) 122 may use the graph in conjunction with local planning or control modules that execute lower-level commands, dynamically adapt to environmental changes, or avoid unforeseen obstacles while following the global route.

In some examples, such as multi-agent scenarios, multiple machines 122 may share access to the same refined waypoint graph data 120 to coordinate movements, avoid collisions, and balance load or traffic across shared regions. For example, the waypoint graph may be distributed to the machine(s) 122 via a centralized planner, cloud-based orchestration system, or edge computing node, depending on system architecture and deployment context. By relying on a refined and optimized waypoint graph, the machine(s) 122 may achieve efficient navigation across a variety of operating conditions while reducing computational overhead and improving scalability.

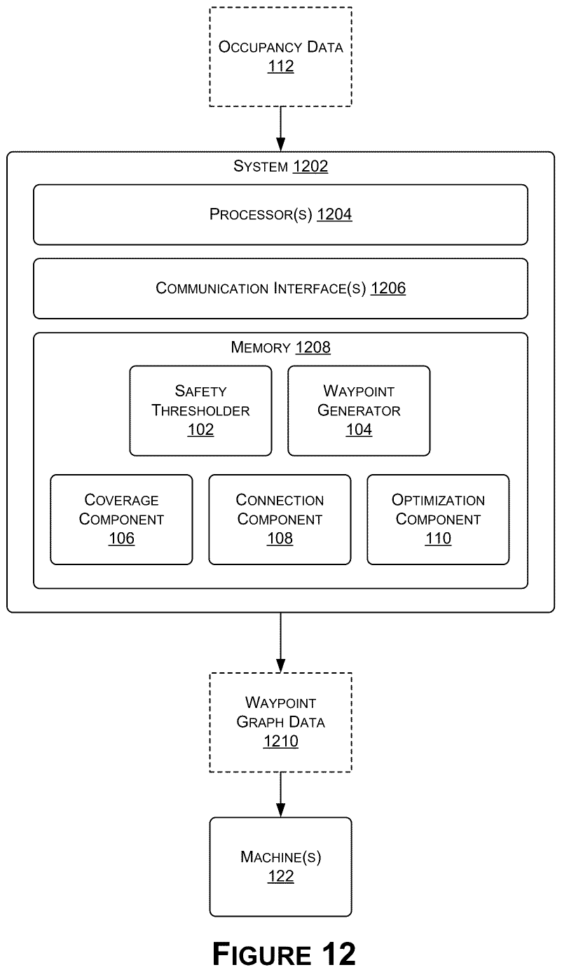

Referring now to FIG. 12, FIG. 12 is a block diagram illustrating example detail associated with a system that may perform one or more of the processes and/or methods described herein, in accordance with some embodiments of the present disclosure. As shown, the system 1202 may include one or more processors 1204 (which may include, and/or be similar to, a CPU(s) 1906 and/or a GPU(s) 1908), one or more communication interfaces 1206 (which may include, and/or be similar to, a communication interface(s) 1910), and a memory 1208 (which may include, and/or be similar to, a memory 1904). As shown, the memory 1208 may store one or more of the safety thresholder 102, the waypoint generator 104, the coverage component 106, the connection component 108, and/or the optimization component 110. Additionally, the processor(s) 1204 may execute one or more of the safety thresholder 102, the waypoint generator 104, the coverage component 106, the connection component 108, and/or the optimization component 110 to perform one or more of the processes, methods, and/or operations described herein.

For instance, and as shown, the system 1202 may receive the occupancy data 112 representing an occupancy map of an environment. The system 1202 may use one or more of the safety thresholder 102, the waypoint generator 104, the coverage component 106, the connection component 108, and/or the optimization component 110 to generate waypoint graph data 1210 representing a sparse-waypoint graph of the environment. The waypoint graph data 1210 may, in some instances, correspond to the waypoint graph data 118 or the refined waypoint graph data 120 from the example of FIG. 1. The system may use one or more communication interfaces 1206 to send the waypoint graph data 120 to the machine(s)122 for use in navigation, planning, or other autonomous operations.

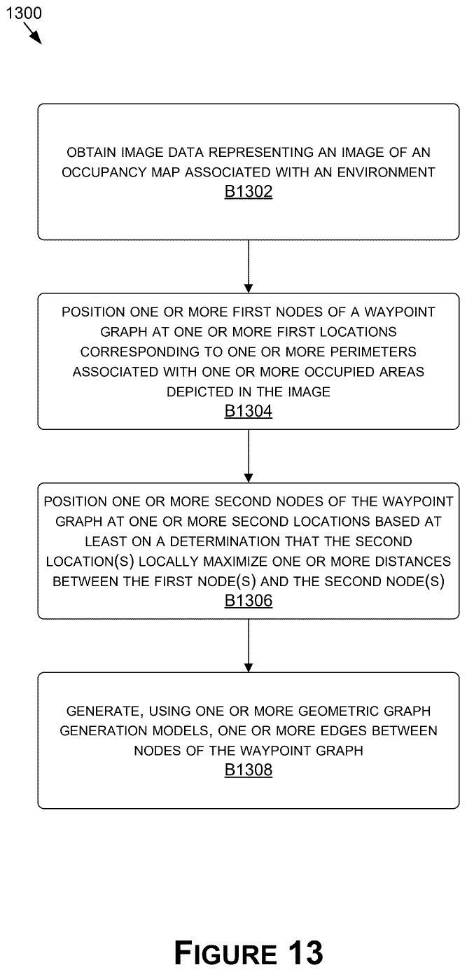

Now referring to FIGS. 13-15, each block of methods 1300, 1400, and 1500, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, methods 1300, 1400, and 1500, are described, by way of example, with respect to FIGS. 1, 4, and 12. However, these methods may additionally or alternatively be executed by any one system, or any combination of systems, including, but not limited to, those described herein.

FIG. 13 is a flow diagram illustrating an example of a method 1300 for generating a waypoint graph based on an occupancy map, in accordance with some embodiments of the present disclosure. The method 1300, at block B1302, may include obtaining image data representing an image of an occupancy map associated with an environment. For instance, the waypoint generator 104 may obtain the image data representing the image of the occupancy map associated with the environment. In some examples, this may include the occupancy data 112 representing the occupancy map and/or the safety map data 114 representing the safety-thresholded version of the occupancy map.

The method 1300, at block B1304, may include positioning one or more first nodes of a waypoint graph at one or more first locations corresponding to one or more perimeters associated with one or more occupied areas depicted in the image. For instance, the positioning component 406 of the waypoint generator 104 may position the first node(s) of the waypoint graph at the first location(s) corresponding to the perimeter(s) associated with the occupied area(s) based on output from the perimeter generator 404, which may analyze the safety map data 114 to identify contours or outlines of occupied regions.

The method 1300, at block B1306, may include positioning one or more second nodes of the waypoint graph at one or more second locations based at least on a determination that the second location(s) locally maximize one or more distances between the first node(s) and the second node(s). For instance, the positioning component 406 of the waypoint generator 104 may position the second node(s) at the second location(s) based at least on the coverage component 106 generating the distance map data 408 and evaluating spatial separation between existing nodes and identifying local maxima.

The method 1300, at block B1308, may include generating, using one or more geometric graph generation models, one or more edges between nodes of the waypoint graph. For instance, the connection component 108 may apply the geometric graph generation model(s)—such as a Delaunay triangulation or other proximity-based model(s)—to connect the nodes of the waypoint graph and output the edge(s) as part of the waypoint graph data 118.

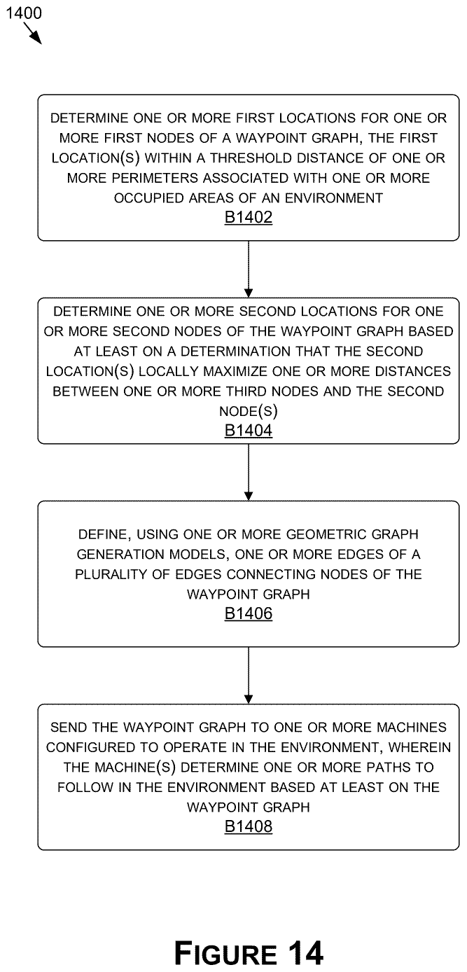

Referring now to FIG. 14, FIG. 14 is a flow diagram illustrating an example of a method 1400 for generating and sending a waypoint graph to one or more machines, in accordance with some embodiments of the present disclosure. The method 1400, at block B1402, may include determining one or more first locations for one or more first nodes of a waypoint graph, the first location(s) within a threshold distance of one or more perimeters associated with one or more occupied areas of an environment. For example, the positioning component 406 of the waypoint generator 104 may determine the first location(s) for the first node(s) based on output of the perimeter generator 404 indicating the perimeter(s) associated with the occupied area(s) (or the unoccupied areas) of the environment.

The method 1400, at block B1404, may include determining one or more second locations for one or more second nodes of the waypoint graph based at least on a determination that the second location(s) locally maximize one or more distances between one or more third nodes and the second node(s). For instance, the positioning component 406 of the waypoint generator 104 may determine the second location(s) for the second node(s) of the waypoint graph based at least on the distance map data 408 indicating the second location(s) that locally maximize the distance(s) between the third node(s) (e.g., existing nodes) and the second node(s).

The method 1400, at block B1406, may include defining, using one or more geometric graph generation models, one or more edges of a plurality of edges connecting nodes of the waypoint graph. For example, the connection component 108 may define the edge(s) connecting the nodes of the waypoint graph using the geometric graph generation models, such as a Delaunay Triangulation model.

The method 1400, at block B1408, may include sending the waypoint graph to one or more machines configured to operate in the environment, wherein the machine(s) determine one or more paths to follow in the environment based at least on the waypoint graph. For instance, the refined waypoint graph data 120 representing the waypoint graph may be sent to the machine(s) 122 and the machine(s) 122 may use the waypoint graph to determine the path(s) to follow in the environment.

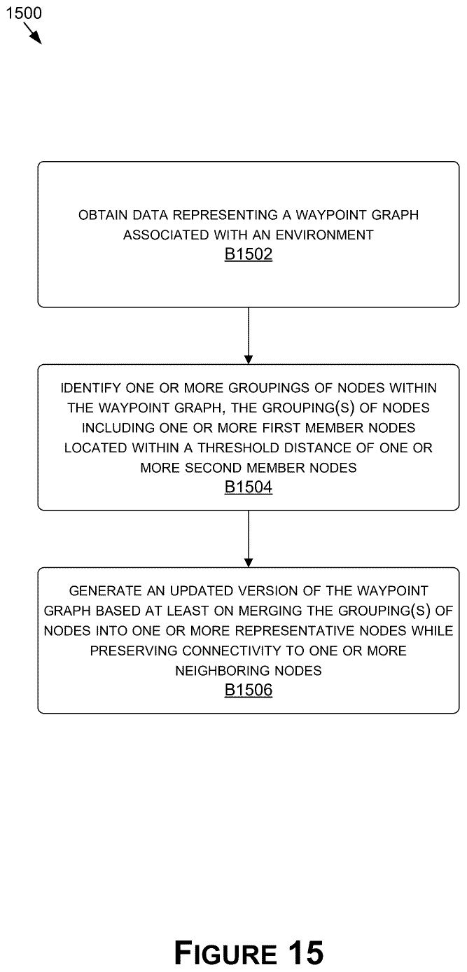

Referring now to FIG. 15, FIG. 15 is a flow diagram illustrating an example of a method 1500 for updating a waypoint graph, in accordance with some embodiments of the present disclosure. The method 1500, at block B1502, may include obtaining data representing a waypoint graph associated with an environment. For instance, the optimization component 110 may obtain the waypoint graph data 118 representing the waypoint graph associated with the environment.

The method 1500, at block B1504, may include identifying one or more groupings of nodes within the waypoint graph, the grouping(s) of nodes including one or more first member nodes located within a threshold distance of one or more second member nodes. For example, the optimization component 110 may identify the grouping(s) of nodes within the waypoint graph based on the grouping(s) including the first member node(s) located within the threshold distance of the second member node(s). That is, the member nodes may be part of the grouping(s) of nodes and the grouping(s) may be identified based on those member nodes being located too closely to one another (e.g., within a threshold distance).

The method 1500, at block B1506, may include generating an updated version of the waypoint graph based at least on merging the grouping(s) of nodes into one or more representative nodes while preserving connectivity to one or more neighboring nodes. For instance, the optimization component 110 may generate the refined waypoint graph data 120 representing the updated version of the waypoint graph by merging the grouping(s) of nodes into the representative node(s) while preserving connectivity to the neighboring node(s), as illustrated in the example of FIGS. 11A and 11B.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 16A is an example of sensor locations having corresponding fields of view or sensory fields for an autonomous or semi-autonomous vehicle 1600a, an autonomous mobile robot (AMR) 1600b, and a humanoid robot 1600c, in accordance with some embodiments of the present disclosure. Although three types of machines 1600 are illustrated, this is not intended to be limiting, and the machine(s) 1600 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1600a, AMR 1600b, humanoid robot 1600c, and/or other machine types may be referred to herein collectively as machine 1600, in some instances.

With respect to vehicles 1600A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1600 may be capable of functionality in accordance with one or more of Level 3-Level 5 of the autonomous driving levels. The machine 1600 may be capable of functionality in accordance with one or more of Level 1-Level 5 of the autonomous driving levels. For example, the machine 1600 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1600 or other machine, such as being fully autonomous, being highly autonomous, being conditionally autonomous, being partially autonomous, providing assistive autonomy, being semi-autonomous, being primarily autonomous, or other designation.

With respect to FIG. 16A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1668D, a 180 degree field of view of a wide-view camera 1670, a 360 degree sensory field of a LiDAR sensor 1664, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1600a, AMR 1600b, and/or humanoid robot 1600c, etc. For example, with respect to the vehicle 1600a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1600b and/or humanoid robot 1600c, the shape, size, purpose, implementation, model, etc. may dictate the number and types of sensors used.

As illustrated in FIG. 1A, the autonomous or semi-autonomous vehicle 1600A, the AMR 1600B, and the humanoid robot 1600C may include different sensor types, number, and locations. For a non-limiting example, the vehicle 1600A may include twelve cameras 1664, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 1664 may use, in embodiments, a gigabit multimedia serial link (GMSL) interface—such as GMSL2—as input/output (I/O).

In some embodiments, although not illustrated in FIG. 16A, the vehicle 1600A may include an in-cabin occupant and/or driver monitoring system, that may include various different sensors. For example, the in-cabin sensors may include various cameras 1668, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 1668, the internal camera(s) 1668 may, in embodiments, use a GMSL (such as GMSL2) interface for I/O.

As another non-limiting example, the vehicle 1600A may further include nine RADAR sensors 1660. For example, the vehicle 1600A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 1660 may use, in embodiments, an Ethernet interface as I/O.

The vehicle(s) 1600A may further include, as a non-limiting example, twelve ultrasonic sensors 1662. As illustrated in FIG. 16A, the ultrasonic sensors may be positioned along the front and rear bumpers of the vehicle 1600A, and along the side of the vehicle 1600A, and may be used to detect objects (static and dynamic) in close proximity to the vehicle 1600A. In some embodiments, the ultrasonic sensor(s) 1662 may use a DS13 interface as I/O.

The vehicle(s) 1600A may further include, as a non-limiting example, a LiDAR sensor 1664, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1664 may include a 360 degree horizontal FOV or sensory field (such as in a spinning LiDAR sensor) and a 90 degree vertical FOV or sensory field. In some embodiment, the LiDAR sensor(s) 1664 may use an Ethernet interface as I/O.

The autonomous mobile robot (AMR) 1600B may include, as a non-limiting example, three LiDAR sensors 1664. For example, the top-most illustrated LiDAR sensor 1664 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1600B may further include, as a non-limiting embodiment, eight cameras 1668, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 1600B may further include a charging port, charging port contacts, a status indicator light, one or more (e.g., four) RGB LEDs, one or more IMU sensors 1666, a magnetometer, and a barometer. The AMR 1600B is capable of high-precision time synchronization between sensors using hardware time stamping, and PTP over Ethernet with less than 10 microseconds for sensor acquisition time. The AMR 1600B provides simultaneous camera capture across all cameras 1668 within 100 microseconds from a single hardware trigger, in embodiments, and can write to disk at 4 GB/second for sensor capture to bag writing (e.g., writing to ROSbags for the robot operation system (ROS)). As such, the AMR 1600B is capable of running the ROS (such as NVIDIA's Isaac ROS), can be teleoperated (as described herein), can map an environment, and can navigate within an environment using visual cameras 1668, LiDARs 1664, and/or other sensor types or modalities.

The humanoid robot 1600C may include, as a non-limiting example, one LiDAR sensor 1664. For example, the LiDAR sensor 1664 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1600C may further include, as a non-limiting embodiment, four cameras 1668, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 1600C may further include, as a non-limiting embodiment, four ultrasonic sensors 1662, such as a left arm ultrasonic sensor, a right arm ultrasonic sensor, a left leg ultrasonic sensor, and right leg ultrasonic sensor.

The humanoid robot 1600C may further include any number of actuators-such as to allow control and maneuverability of joints. For example, the humanoid robot 1600C may include actuators that allow for various degrees of freedom (DoF) depending on the design. In a non-limiting embodiment, the humanoid robot 1600C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1600C may include position and orientation sensors, such as encoders, gyroscopes, and the like, to determine the position of the robot 1600C in space, allowing for location determination and movement tracking. The humanoid robot 1600C may include force and pressure sensors, in embodiments, to detect environment interactions, allowing the robot 1600C to grasp objects with the right force and to avoid obstacles along the way. The perception sensors (e.g., cameras, LiDARs, RADARs, ultrasonic, SONAR, etc.) may be used along with tactile sensors to allow the robot 1600C to perceive objects, shapes, and textures, and to understand when touch is initiated and stopped (along with force sensors that regulate the force used during touch). As a non-limiting example, the humanoid robot 1600C may have a height of about 1-2 meters (e.g., 1.7 meters or 5′6″), a weight of 50-70 kg, be capable of moving at a speed of 8 or more km/h, and be able to carry payloads anywhere from 20-100 kg, depending on the design and requirements of the system.

The humanoid robot 1600C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1600C may use onboard sensors, microphones, and speakers to understanding speech, audio and visual cues, etc., while also being able to communicate back to the environment.

With reference to cameras 1668 of the machine(s) 1600, the camera types for the cameras 1668 may include, but are not limited to, digital cameras that may be adapted for use with the components and/or systems of the machine 1600. For a vehicle 1600a implementation, the camera(s) 1668 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1600 (e.g., front-facing cameras) may be used for surround view, to help identify forward facing paths and obstacles, as well aid in, with the help of one or more controllers 1636 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1668B that may be used to perceive objects coming into view from the periphery (e.g., pedestrians, warehouse vehicles, other robots, crossing traffic, or bicycles). In addition, any number of long-range camera(s) 1668E (e.g., a long-view stereo camera pair) may be used for depth-based object detection, especially for objects for which a neural network has not yet been trained. The long-range camera(s) 1668E may also be used for object detection and classification, as well as basic object tracking.

Any number of stereo cameras 1668A may also be included in a front-facing and/or other (e.g., rear-facing) configuration. In at least one embodiment, one or more of stereo camera(s) 1668A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1600 environment, including a distance estimate for points in the image (e.g., a disparity or depth image). An alternative stereo camera(s) 1668A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1668A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1600 (e.g., side-view cameras) may be used, for example, for surround view, providing information used to create and update the occupancy grid, as well as to generate side impact collision warnings and/or to indicate to an AMR 1600B or humanoid robot 1600C, for example, that there are objects, features, and/or persons present to the side. For example, surround camera(s) 1668D may be positioned on the machine 1600. The surround camera(s) 1668D may include wide-view camera(s) 1668B, fisheye camera(s), 360 degree camera(s), and/or the like. For example, four fisheye cameras may be positioned on the machine's 1600 front, rear, and sides. In an alternative arrangement, the machine 1600 may use three surround camera(s) 1668D (e.g., left, right, and rear), and may leverage one or more other camera(s) (e.g., a forward-facing camera) as a fourth surround view camera.

Cameras 1668 with a field of view that include portions of the environment to the rear of the machine 1600 (e.g., rear-view cameras) may be used for gaining an understanding of objects, features, persons, and/or other information to the rear of the machine 1600, such as for park assistance, surround view, rear collision warnings, planning, control, and navigation determinations, and/or creating and updating an occupancy grid, BEV image representing the environment, height map, etc. A wide variety of cameras 1668 may be used including, but not limited to, cameras 1668 that are also suitable as a front-facing camera(s) (e.g., long-range and/or mid-range camera(s) 1668E, stereo camera(s) 1668A), infrared camera(s) 1668C, etc.), rear-facing camera(s), side-facing camera(s), downward facing camera(s), upward facing camera(s), and/or the like, as described herein.

Similarly, for LiDAR sensors 1664, RADAR sensors 1660, ultrasonic sensors 1662, and/or other sensor modalities or types, the location and placement of the sensors, and their corresponding fields of view or sensory fields may be determined based on the use case, implementation, or design of the particular machine 1600.

For example, the machine(s) 1600 include RADAR sensor(s) 1660 that may be used by the machine 1600 for long-range object detection, even in darkness and/or severe weather conditions. RADAR functional safety levels may be ASIL B, in embodiments. The RADAR sensor(s) 1660 may use the CAN and/or the bus 1602 (e.g., to transmit data generated by the RADAR sensor(s) 1660) for control and to access object tracking data, with access to Ethernet to access raw data in some examples. A wide variety of RADAR sensor types may be used. For example, and without limitation, the RADAR sensor(s) 1660 may be suitable for front, rear, and side RADAR use. In some example, Pulse Doppler RADAR sensor(s) are used.

The RADAR sensor(s) 1660 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 1660 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1600 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1660 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1600 (e.g., vehicle, robot, etc.). As such, short-range RADAR systems may be used in an ADAS system for blind spot detection and/or lane change assist.

The machine 1600 may further include ultrasonic sensor(s) 1662. The ultrasonic sensor(s) 1662, which may be positioned at the front, back, and/or the sides of the machine 1600, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1600. A wide variety of ultrasonic sensor(s) 1662 may be used, and different ultrasonic sensor(s) 1662 may be used for different ranges of detection (e.g., 2.5 m, 4 m). The ultrasonic sensor(s) 1662 may operate at functional safety levels of ASIL B, as an example.

The machine 1600 may include LiDAR sensor(s) 1664. The LiDAR sensor(s) 1664 may be used for object and feature detection, pedestrian and other robot detection, emergency braking, collision avoidance, simultaneous localization and mapping (SLAM), free-space detection, and/or other functions. The LiDAR sensor(s) 1664 may be functional safety level ASIL B, in embodiments. In some examples, the machine 1600 may include multiple LiDAR sensors 1664 (e.g., two, four, six, etc.) that may use Ethernet (e.g., to provide data to a Gigabit Ethernet switch).

In some examples, the LiDAR sensor(s) 1664 may be capable of providing a list of objects and their distances for a 360-degree field of view. Commercially available LiDAR sensor(s) 1664 may have an advertised range of approximately 1600m, with an accuracy of 2 cm-3 cm, and with support for a 1600 Mbps Ethernet connection, for example. In some examples, one or more non-protruding LiDAR sensors 1664 may be used. In such examples, the LiDAR sensor(s) 1664 may be implemented as a small device that may be embedded into the front, rear, sides, top, and/or corners of the machine 1600. The LiDAR sensor(s) 1664, in such examples, may provide up to a 120-degree horizontal and 35-degree vertical field-of-view, with a 200 m range even for low-reflectivity objects. Front-mounted LiDAR sensor(s) 1664 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1600. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1664 may be less susceptible to motion blur, vibration, and/or shock.

FIG. 16B is an illustration of sensor and component locations of an example autonomous or semi-autonomous vehicle 1600A (alternatively referred to herein as “vehicle 1600,” “ego-vehicle 1600,” “ego-machine 1600,” or “machine 1600,”), in accordance with some embodiments of the present disclosure. Although the vehicle 1600A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 16C is a block diagram of an example system architecture for a machine 1600, such as autonomous or semi-autonomous vehicle 1600A, autonomous mobile robot (AMR) 1600B, humanoid robot 1600C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1600 of FIGS. 16A-16E, example computing ecosystem 1700 of FIG. 17, example generative language model system 1800 of FIG. 18, and/or example computing device 1900 of FIG. 19.

Each of the components, features, and systems of the machine 1600 in FIG. 16C are illustrated as being connected via bus 1602 (alternatively referred to as a “machine communications network 1602,” or just “communications network 1602”). The bus 1602 may include a Controller Area Network (CAN) data interface (alternatively referred to herein as a “CAN bus”). A CAN may be a network inside the machine 1600 used to aid in control of various features and functionality of the machine 1600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1602 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1602, this is not intended to be limiting. For example, there may be any number of busses 1602, which may include one or more CAN busses, one or more FlexRay busses, one or more Ethernet busses, and/or one or more other types of busses using a different protocol. In some examples, two or more busses 1602 may be used to perform different functions, and/or may be used for redundancy. For example, a first bus 1602 may be used for collision avoidance functionality and a second bus 1602 may be used for actuation control. In any example, each bus 1602 may communicate with any of the components of the machine 1600, and two or more busses 1602 may communicate with the same components. In some examples, each SoC 1604, each controller 1636, and/or each computer or compute engine within the machine 1600 may have access to the same input data (e.g., inputs from sensors of the machine 1600), and may be connected to a common bus, such as a CAN bus.

The machine 1600 may include components such as a chassis, a vehicle body, wheels (e.g., 2, 4, 6, 8, 18, etc.), tires, axles, batteries, side-view mirrors, and/or other components of a vehicle or machine. The machine 1600 may include a propulsion system 1650, such as an internal combustion engine, hybrid electric power plant, an all-electric engine, a hydrogen-fueled engine, and/or another propulsion system type. The propulsion system 1650 may be connected to a drive train of the machine 1600, which may include a transmission, to enable the propulsion of the machine 1600. The propulsion system 1650 may be controlled in response to receiving signals from the throttle/accelerator 1652.

A steering system 1654, which may include a steering wheel and/or other steering device (e.g., remote steering and/or local steering), may be used to steer the machine 1600 (e.g., along a desired path or route) when the propulsion system 1650 is operating (e.g., when the vehicle is in motion). The steering system 1654 may receive signals from a steering actuator 1656. In some embodiments, a steering wheel or other steering mechanism may not be included, such as for a machine 1600 capable of full automation (e.g., Level 5) functionality.

The brake sensor system 1646 may be used to operate the vehicle brakes in response to receiving signals from the brake actuators 1648 and/or brake sensors.

The machine 1600 may include one or more controller(s) 1636, such as those described herein with respect to FIG. 16A. The controller(s) 1636 may be used for a variety of functions, and may be coupled to any of the various other components and systems of the machine 1600. For example, the controllers 1636 may be used for control of the machine 1600, artificial intelligence executing on the machine 1600, infotainment for the machine 1600, and/or the like. For example, one controller 1636 may be used for some or all of the functionality, or different controllers 1636 may be used for different functionalities—e.g., to ensure availability and a safety separation between various controllers for different tasks. For example, the controller(s) 1636 may use plans computed by the system—e.g., paths or trajectories for vehicles 1600A or AMRs 1600B, or movements, components trajectories, movement locations or displacements, etc. for joints or components (e.g., of manipulators, end effectors, limbs, hands, fingers, legs, feet, etc.), of a humanoid robot 1600C—to control the machine(s) 1600 in the environment. In some instances, the controller(s) 1636 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1600C, for example, the controller(s) 1636 may act as the brain, responsible for analyzing sensor data, making decisions, and sending commands to the actuators. The controller(s) 1636 may include a low-level controller that handles basic motor control, ensuring accurate and precise movements of individual joints and actuators. The controller(s) 1636 may include a high-level controller to coordinate multiple actuators and sensors, planning complex motions and adapting to changing environments.

The controller(s) 1636 may include an artificial intelligence controller, in embodiments, that may use AI algorithms (e.g., DNNs, MLMs, etc.) to learn, make decisions, and autonomously perform tasks for the machine 1600. In some embodiments, the controller(s) 1636 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1636 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1636, which may include one or more systems on chip (SoCs) 1604 (FIGS. 16C and 16D), CPUs, GPU(s), accelerator(s), etc., may provide signals (e.g., representative of commands or messages) to one or more components and/or systems of the machine 1600. Although the controller(s) 1636 is listed separately from the SoC(s) 1604, this is not intended to be limiting, and in some embodiments one or more components of the SoC(s) 1604 may perform the operations of the controller(s) 1636. For example, the controller(s) may send signals to operate the machine brakes via one or more brake actuators 1648, to operate the steering system 1654 via one or more steering actuators 1656, to operate the propulsion system 1650 via one or more throttle/accelerators 1652, etc. The controller(s) 1636 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1600. The controller(s) 1636 may include a first controller 1636 for autonomous control and navigation functions, a second controller 1636 for functional safety functions, a third controller 1636 for artificial intelligence functionality (e.g., computer vision), a fourth controller 1636 for infotainment functionality, a fifth controller 1636 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1636 may handle two or more of the above functionalities, two or more controllers 1636 may handle a single functionality, and/or any combination thereof.

The controller(s) 1636 may provide the signals for controlling one or more components and/or systems of the machine 1600 in response to sensor data received from one or more sensors (e.g., sensor inputs). The sensor data may be received from, for example and without limitation, global navigation satellite systems (“GNSS”) sensor(s) 1658 (e.g., Global Positioning System sensor(s)), RADAR sensor(s) 1660, ultrasonic sensor(s) 1662, LiDAR sensor(s) 1664, inertial measurement unit (IMU) sensor(s) 1666 (e.g., accelerometer(s), gyroscope(s), magnetic compass(es), magnetometer(s), etc.), microphone(s) 1696, camera(s) 1668 (e.g., stereo camera(s) 1668A, wide-view camera(s) 1668B (e.g., fisheye cameras), infrared camera(s) 1668C, surround camera(s) 1668D (e.g., 360 degree cameras), long-range and/or mid-range camera(s) 1668E, and/or other camera types), speed sensor(s) 1644 (e.g., for measuring the speed of the machine 1600), vibration sensor(s) 1642, steering sensor(s) 1640, brake sensor(s) (e.g., as part of the brake sensor system 1646), actuators, and/or other sensor types.

One or more of the controller(s) 1636 may receive inputs (e.g., represented by input data) from an instrument cluster 1632 of the machine 1600 and provide outputs (e.g., represented by output data, display data, etc.) via a human-machine interface (HMI) display 1634 (e.g., screen, heads-up display, mirror display, facial display, robotic display, etc.), an audible annunciator, a loudspeaker, a speaker, and/or via other components of the machine 1600. The outputs may include information such as machine velocity, speed, time, map data corresponding to a map(s) 1622 of FIG. 16C (e.g., from a navigation map, a Standard Definition (SD) map, a High Definition (“HD”) map, etc.), location data (e.g., the machine's 1600 location, such as on a map 1622), direction, location of other vehicles (e.g., an occupancy map, height map, bird's eye view (BEV) image, grid, etc.), information about objects and status of objects as perceived by the system, system status information, etc. For example, the HMI display(s) 1634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1600 may include one or more systems on a chip (SoCs) 1604 (described in more detail in FIG. 16D). The SoC(s) 1604 may include CPU(s) 1606, GPU(s) 1608, processor(s) 1610, cache(s) 1612, accelerator(s) 1614, data store(s) 1616, and/or other components and features. The SoC(s) 1604 may be used to process and provide data for various operations, such as navigation, planning, reasoning, inference, perception, control, and/or actuation operations of the machine 1600 in a variety of platforms and systems. For example, the SoC(s) 1604 may process live perception data (e.g., from camera, LiDAR, RADAR, ultrasonic, etc.) in addition to map data corresponding to one or more maps 1622 (e.g., HD map, SD map, navigational map, occupancy map, etc.) in order to make or aid in performing various operations of the machine 1600. Where a map and/or AI is used, map and/or AI (e.g., model parameter updates, fine-tuning, etc.) refreshes and/or updates via a network interface 1624 from one or more servers (e.g., server(s) 1678 of FIG. 16E)—such as one or more servers of a cloud-based data center.

Although an SoC(s) 1604 is illustrated throughout FIGS. 16A-16E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1600, use of the machine 1600, model of the machine 1600, and required capabilities of the machine 1600, one or more SoCs 1604 and/or alternative architectures and/or components may be used to satisfy the particular implementation.

The machine 1600 may include a CPU(s) 1618 (e.g., discrete CPU(s), or dCPU(s)), that may be coupled to the SoC(s) 1604 via a high-speed interconnect (e.g., PCIe). The CPU(s) 1618 may include an X86 processor, for example. The CPU(s) 1618 may be used to perform any of a variety of functions, including arbitrating potentially inconsistent results between ADAS sensors and the SoC(s) 1604, and/or monitoring the status and health of the controller(s) 1636 and/or infotainment SoC 1630, for example.

The machine 1600 may include a GPU(s) 1620 (e.g., discrete GPU(s), or dGPU(s)), that may be coupled to the SoC(s) 1604 via a high-speed interconnect (e.g., NVIDIA's NVLink). The GPU(s) 1620 may provide additional artificial intelligence functionality, such as by executing redundant and/or different neural networks, and may be used to train and/or update neural networks based on input (e.g., sensor data) from sensors of the machine 1600.

The machine 1600 may further include the network interface 1624 which may include one or more wireless antennas 1626 and/or modems (e.g., one or more wireless antennas for different communication protocols, such as a cellular antenna, a Bluetooth antenna, etc.). The network interface 1624 may be used to enable wireless connectivity over the Internet with the cloud (e.g., with the server(s) 1678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1600 information about vehicles in proximity to the machine 1600 (e.g., vehicles in front of, on the side of, and/or behind the machine 1600). This functionality may be part of a cooperative adaptive cruise control functionality of the machine 1600.

The network interface 1624 may include a SoC that provides modulation and demodulation functionality and enables the controller(s) 1636 to communicate over wireless networks. The network interface 1624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1626 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1600 may further include data store(s) 1628 which may include off-chip (e.g., off the SoC(s) 1604) storage. The data store(s) 1628 may include one or more storage elements including RAM, SRAM, DRAM, VRAM, Flash, hard disks, and/or other components and/or devices that may store at least one bit of data.

The machine 1600 may further include GNSS sensor(s) 1658. The GNSS sensor(s) 1658 (e.g., GPS, assisted GPS sensors, differential GPS (DGPS) sensors, etc.), to assist in mapping, perception, occupancy grid generation, and/or path planning functions. Any number of GNSS sensor(s) 1658 may be used, including, for example and without limitation, a GPS using a USB connector with an Ethernet to Serial (RS-232) bridge.

The machine 1600 may further include IMU sensor(s) 1666. The IMU sensor(s) 1666 may be located at a center of the rear axle of the machine 1600, in some examples. The IMU sensor(s) 1666 may include, for example and without limitation, an accelerometer(s), a magnetometer(s), a gyroscope(s), a magnetic compass(es), and/or other sensor types. In some examples, such as in six-axis applications, the IMU sensor(s) 1666 may include accelerometers and gyroscopes, while in nine-axis applications, the IMU sensor(s) 1666 may include accelerometers, gyroscopes, and magnetometers.

In some embodiments, the IMU sensor(s) 1666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1666 may enable the machine 1600 to estimate heading without requiring input from a magnetic sensor by directly observing and correlating the changes in velocity from GPS to the IMU sensor(s) 1666. In some examples, the IMU sensor(s) 1666 and the GNSS sensor(s) 1658 may be combined in a single integrated unit.

The vehicle may include one or more microphone 1696 placed in and/or around the machine 1600. The microphone(s) 1696 may be used for emergency vehicle detection and identification, among other things.

The machine 1600 may further include vibration sensor(s) 1642. The vibration sensor(s) 1642 may measure vibrations of components of the machine, such as the arms or legs of a humanoid robot 1600C, or the axle(s) of a vehicle 1600A or AMR 1600B. For example, changes in vibrations may indicate a change in road, walking, or traversable surfaces. In another example, when two or more vibration sensors 1642 are used, the differences between the vibrations may be used to determine friction or slippage of the surface (e.g., when the difference in vibration is between a power-driven axle and a freely rotating axle).

The machine 1600 may include an ADAS system 1638—such as when the machine 1600 is a vehicle 1600A. The ADAS system 1638 may include a dedicated SoC(s), in some examples. The ADAS system 1638 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1600 may further include the infotainment SoC 1630 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1600. For example, the infotainment SoC 1630 may radios, disk players, navigation systems, video players, USB and Bluetooth connectivity, carputers, in-car entertainment, Wi-Fi, steering wheel audio controls, hands free voice control, a heads-up display (HUD), an HMI display 1634, a telematics device, a control panel (e.g., for controlling and/or interacting with various components, features, and/or systems), and/or other components. The infotainment SoC 1630 may further be used to provide information (e.g., visual and/or audible) to a user(s) of the vehicle, such as information from the ADAS system 1638, autonomous driving information such as planned vehicle maneuvers, trajectories, surrounding environment information (e.g., intersection information, vehicle information, road information, etc.), and/or other information.

The infotainment SoC 1630 may include GPU functionality. The infotainment SoC 1630 may communicate over the bus 1602 (e.g., CAN bus, Ethernet, etc.) with other devices, systems, and/or components of the machine 1600. In some examples, the infotainment SoC 1630 may be coupled to a supervisory MCU such that the GPU of the infotainment system may perform some self-driving functions in the event that the primary controller(s) 1636 (e.g., the primary and/or backup computers of the machine 1600) fail. In such an example, the infotainment SoC 1630 may put the machine 1600 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1600—whether a vehicle 1600A, AMR 1600B, humanoid robot 1600C, and/or other type of machine—may include a locally stored language model(s) and/or communicate to a remotely hosted language model (e.g., via one or more APIs) to provide more detailed and in-depth communication features to the users of the machine(s) 1600.

In some examples, an infotainment SoC 1630, the SoC(s) 1604, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1600. The always on sensor processing engine may be used to unlock the vehicle when the owner approaches the driver door and turn on the lights, and, in security mode, to disable the vehicle when the owner leaves the vehicle. In this way, the SoC(s) 1604 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1600.

The machine 1600 may further include an instrument cluster 1632 (e.g., a digital dash, an electronic instrument cluster, a digital instrument panel, etc.). The instrument cluster 1632 may include a controller and/or supercomputer (e.g., a discrete controller or supercomputer). The instrument cluster 1632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1630 and the instrument cluster 1632. In other words, the instrument cluster 1632 may be included as part of the infotainment SoC 1630, or vice versa.

FIG. 16D is a block diagram of an example architecture of a computing system (a subset of the system described with respect to FIG. 16C), in accordance with at least some embodiments of the present disclosure. Although illustrated as an SoC(s) 1604, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1604 may be an end-to-end platform with a flexible architecture that spans automation levels 2-5, or the SoC(s) 1604 may be specifically designed for a specific automation level (e.g., a first SoC 1604 for level 2 to level 2++, a second SoC 1604 for level 3, a third SoC 1604 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1604 may be faster, more reliable, and even more energy-efficient and space-efficient than conventional systems. For example, the accelerator(s) 1614, when combined with the CPU(s) 1606, the GPU(s) 1608, and the data store(s) 1616, may provide for a fast, efficient platform for level 2-5 autonomous vehicles as well as for safe planning, navigation, and control of AMRs 1600B, humanoid robots 1600C, and/or other robot or machine types.

In some embodiments, such as where the SoC(s) 1604 include a GPU 1608 with 2000 or more cores (e.g., 2048 cores), 60 or more tensor cores (e.g., 64 tensor cores), and a GPU max frequency of over 1 GHz (e.g., 1.3 GHz), a CPU 1606 including 10 or more cores (e.g., 12 cores), with 64 bits, 3MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1609 (e.g., 2 DLAs/XNNs/NNAs/NPUs 1609), and a vision accelerator-such as a programmable vision accelerator (PVA) 1607, a single SoC 1604) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1604 include a GPU 1608 with 1700 or more cores (e.g., 1792 cores), 50 or more tensor cores (e.g., 56 tensor cores), and a GPU max frequency of over 900 MHz (e.g., 930 MHz), a CPU 1606 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1609 (e.g., 2 DLAs/XNNs/NNAs/NPUs 1609), and a vision accelerator-such as a programmable vision accelerator (PVA) 1607, a single SoC 1604) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1604 include a GPU 1608 with 1000 or more cores (e.g., 1024 cores), 28 or more tensor cores (e.g., 32 tensor cores), and a GPU max frequency of over 900 MHz (e.g., 1173 MHz), a CPU 1606 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 1609 (e.g., 1 DLA/XNN/NNA/NPU 1609), and a vision accelerator—such as a programmable vision accelerator (PVA) 1607, a single SoC 1604) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1604 include a GPU 1608 with 1000 or more cores (e.g., 1024 cores), 28 or more tensor cores (e.g., 32 tensor cores), and a GPU max frequency of over 900 MHz (e.g., 1020 MHz), a CPU 1606 including 6 or more cores (e.g., 6 cores), with 64 bits, 1.5 MB L2 and 4 MB L3 cache memory, and a max frequency of 1.5 or more GHz (e.g., 1.7 GHz), a single SoC 1604) may be capable of 67 tera operations per second (TOPS) of AI performance. For example, NVIDIA's Jetson Orin Nano 8 GB SoC satisfies these criteria, and achieves this performance.

The SoC(s) 1604 may include one or more CPUs 1606. The CPU(s) 1606 may include a CPU cluster or CPU complex (alternatively referred to herein as a “CCPLEX”), in embodiments. The CPU(s) 1606 may include multiple cores and/or (e.g., L2, L3) caches. For example, in some embodiments, the CPU(s) 1606 may include twelve cores in a coherent multi-processor configuration. In some embodiments, the CPU(s) 1606 may include four dual-core clusters where each cluster has a dedicated L2 cache (e.g., a 3 MB L 2 cache). The CPU(s) 1606 (e.g., the CCPLEX) may be configured to support simultaneous cluster operation enabling any combination of the clusters of the CPU(s) 1606 to be active at any given time.

The SoC(s) 1604 may include any type and number of GPUs 1608. For example, an integrated GPU(s) (alternatively referred to herein as an “iGPU(s)”) may be used in some embodiments. The GPU(s) 1608 may be programmable and may be efficient for parallel workloads. The GPU(s) 1608, in some examples, may use an enhanced tensor instruction set. The GPU(s) 1608 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1608 may include at least eight streaming microprocessors. The GPU(s) 1608 may use compute application programming interface(s) (API(s)). In addition, the GPU(s) 1608 may use one or more parallel computing platforms and/or programming models (e.g., NVIDIA's CUDA).

The GPU(s) 1608 may be power-optimized for best performance in automotive, robotics, and/or other embedded use cases. For example, the GPU(s) 1608 may be fabricated on a Fin field-effect transistor (FinFET). However, this is not intended to be limiting and the GPU(s) 1608 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP 32 cores, 8 FP64 cores, 16 INT 32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1608 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1608 to access the CPU(s) 1606 page tables directly. In such examples, when the GPU(s) 1608 memory management unit (MMU) experiences a miss, an address translation request may be transmitted to the CPU(s) 1606. In response, the CPU(s) 1606 may look in its page tables for the virtual-to-physical mapping for the address and transmits the translation back to the GPU(s) 1608. As such, unified memory technology may allow a single unified virtual address space for memory of both the CPU(s) 1606 and the GPU(s) 1608, thereby simplifying the GPU(s) 1608 programming and porting of applications to the GPU(s) 1608.

The SoC(s) 1604 may include any number of cache(s) 1612, including those described herein. For example, the cache(s) 1612 may include L0 caches, L1 caches, L2 caches, L3 caches (e.g., that are available to both the CPU(s) 1606 and the GPU(s) 1608 (e.g., that is connected both the CPU(s) 1606 and the GPU(s) 1608)), etc. The cache(s) 1612 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1604 may include one or more arithmetic logic units (ALUs) 1665 which may be leveraged in performing processing with respect to any of the variety of tasks or operations of the machine 1600—such as computer vision, machine learning or deep learning processing, world model management, etc. In addition, the SoC(s) 1604 may include a floating point unit(s) (FPU(s)) 1667—or other math coprocessor or numeric coprocessor types—for performing mathematical operations within the system. For example, the SoC(s) 1604 may include one or more FPUs 1667 integrated as execution units within a CPU(s) 1606 and/or GPU(s) 1608.

The SoC(s) 1604 may include one or more accelerators 1614 (e.g., hardware accelerators, software accelerators, or a combination thereof). For example, the SoC(s) 1604 may include a hardware acceleration cluster that may include optimized hardware accelerators and/or large on-chip memory. The large on-chip memory 1615 (e.g., 4 MB of SRAM, 32 GB and/or 64 GB 256-bit LPDDR5 at 204.8 GB/s, 8 GB and/or 16 GB 128-bit LPDDR 5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1608 and to off-load some of the tasks of the GPU(s) 1608 (e.g., to free up more cycles of the GPU(s) 1608 for performing other tasks). As an example, the accelerator(s) 1614 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1614 (e.g., the hardware acceleration cluster) may include a deep learning accelerator(s) (DLA) 1609 (alternatively referred to herein as “a deep learning accelerator cluster (XNN) 1609,” “neural network accelerator (NNA) 1609,” or “neural processing unit (NPU) 1609”). The DLA(s) 1609 may include one or more Tensor processing units (TPUs) 1641 that may be configured to provide an additional, e.g., ten trillion operations per second for deep learning applications and inferencing. The TPUs 1641 may be accelerators configured to, and optimized for, performing image processing functions (e.g., for CNNs, RCNNs, DNNs, etc.). The DLA(s) 1609 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1641 may perform several functions, including a single-instance convolution function, supporting, for example, INT8, INT16, and FP16 data types for both features and weights, as well as post-processor functions. Although the TPU(s) 1641 are described as being included as part of the DLA(s) 1609, this is not intended to be limiting, and the TPU(s) 1641 may be included in additional or alternative accelerator(s) 1614 and/or other components, and/or may be included as a discrete processing component(s).

The DLA(s) 1609 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1609 may perform any function of the GPU(s) 1608, and by using an inference accelerator, for example, a designer may target either the DLA(s) 1609 or the GPU(s) 1608 for any function. For example, the designer may focus processing of DNNs and floating point operations on the DLA(s) 1609 and leave other functions to the GPU(s) 1608 and/or other accelerator(s) 1614. The DLA(s) 1609 may be used to run any type of network to enhance control and safety, including for example, a neural network that outputs a measure of confidence for each object detection.

The accelerator(s) 1614 (e.g., the hardware acceleration cluster) may include a programmable vision accelerator(s) (PVA) 1607, which may alternatively be referred to herein as a computer vision accelerator or generally a vision accelerator. The PVA(s) 1607 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1607 may provide a balance between performance and flexibility. For example, each PVA(s) 1607 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1607 may be optimized for the tasks of image processing and computer vision algorithm acceleration. For example, the PVA(s) 1607 provides excellent performance with extremely low power consumption, and can be used asynchronously and concurrently with the CPU(s) 1606, GPU(s) 1608, and/or other accelerators in the system (e.g., vehicle, robot, etc.) as part of a heterogeneous compute pipeline.

The PVA(s) 1607 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 1643 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 1606 (e.g., ARM Cortex-R5 processor), facilitating data exchange with the CPU(s) 1606 and other system-level components. The VPU I-cache may supply instruction data to the VPU(s) when requested, may request missing instruction data from system memory, and/or may maintain temporary instruction storage for the VPU. For each VPU task, the CPU(s) 1606 may configures the DMA system, optionally prefetch the VPU program into VPU I-cache, and/or kick off each VPU-DMA pair to process a task. The PVA(s) 1607 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP 32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1607 to access the system memory independently of the CPU(s) 1606. The DMA may support any number of features used to provide optimization to the PVA(s) 1607 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1607 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1607, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1607 may be configured to employ data parallelism. For example, in some embodiments, the plurality of vector processors included in a single PVA(s) 1607 may execute the same computer vision algorithm, but on different regions of an image. In other examples, the vector processors included in a particular PVA(s) 1607 may simultaneously execute different computer vision algorithms, on the same image, or even execute different algorithms on sequential images or portions of an image. Among other things, any number of PVAs 1607 may be included in the hardware acceleration cluster and any number of vector processors may be included in each of the PVAs. In addition, the PVA(s) 1607 may include additional error correcting code (ECC) memory, to enhance overall system safety.

The accelerator(s) 1614 (e.g., the hardware accelerator cluster) have a wide array of uses for autonomous and semi-autonomous machine control. The PVA(s) 1607 may be a programmable vision accelerator that may be used for key processing stages in perception, robotics understanding and reasoning, ADAS, semi-autonomous, and autonomous vehicles, etc. The PVA's 1607 capabilities are a good match for algorithmic domains needing predictable processing, at low power and low latency. In other words, the PVA(s) 1607 performs well on semi-dense or dense regular computation, even on small data sets, which need predictable run-times with low latency and low power. Thus, in the context of platforms for autonomous vehicles and robotics, the PVAs 1607 are designed to run classic computer vision algorithms, as they are efficient at object detection and operating on integer math.

For example, according to one embodiment of the technology, the PVA 1607 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1607 may perform computer stereo vision function on inputs from two monocular cameras.

In some examples, the PVA(s) 1607 may be used to perform dense optical flow. According to process raw RADAR data (e.g., using a 4D Fast Fourier Transform) to provide Processed RADAR. In other examples, the PVA(s) 1607 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1607, this is not intended to be limiting. In some embodiments, these components may be included in alternative or additional processing components and/or accelerator(s) 1614, and/or may be included as discrete components of the SoC(s) 1604 and/or other computing system architecture(s).

In some examples, the SoC(s) 1604 may include a real-time ray-tracing hardware accelerator (RTA) 1651 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1600 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1651 and/or a ray-tracing optimized GPU 1606—such as NVIDIA's RTX GPU.

The accelerator(s) 1614 (e.g., in the hardware acceleration cluster) may include one or more optical flow accelerators (OFAs) 1611. For example, the OFA(s) 1611 may be used for computing optical flow and stereo disparity between frames of sensor data (e.g., images). Optical flow may be accelerated on the OFA(s) 1611 for uses such as object detection and tracking, and/or for stereo depth estimation where used for computing stereo disparity between stereo image frames (e.g., two or more frames captured using two or more image sensors with at least partially overlapping fields of view).

The SoC(s) 1604 may include one or more camera serial interfaces (CSIs) 1623. For example, the CSI(s) 1623 may include a mobile industry processor interface (MIPI) camera serial interface (CSI) for receiving video and input from cameras, a high-speed interface, and/or a video input block that may be used for camera and related pixel input functions. The SoC(s) 1604 may further include an input/output controller(s) that may be controlled by software and may be used for receiving I/O signals that are uncommitted to a specific role. For example, the CSI 1623 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 1614 (e.g., the hardware acceleration cluster) may include a computer vision network on-chip (CVNOC) 1663 and SRAM, for providing a high-bandwidth, low latency SRAM for the accelerator(s) 1614. In some examples, the on-chip memory may include at least 4 MB SRAM, consisting of, for example and without limitation, eight field-configurable memory blocks, that may be accessible by the PVA 1607, OFA 1611, DLA 1609, and/or other accelerator(s) 1614. Each pair of memory blocks may include an advanced peripheral bus (APB) interface, configuration circuitry, a controller, and a multiplexer. Any type of memory 1615 may be used. The PVA 1607, OFA 1611, DLA 1609, and/or other accelerator(s) 1614 may access the memory via a backbone that provides the accelerator(s) 1614 with high-speed access to memory. The backbone may include a computer vision network on-chip that interconnects the accelerator(s) 1614 to the memory (e.g., using the APB).

The CVNOC 1663 may include an interface that determines, before transmission of any control signal/address/data, that the accelerator(s) 1614 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1604 may include data store(s) 1616 and/or memory 1615. The data store(s) 1616 may be on-chip memory 1615 of the SoC(s) 1604, which may store neural networks and/or other algorithms to be executed on the CPU(s) 1606, the GPU(s) 1608, and/or one or more of the accelerator(s) 1614. In some examples, the data store(s) 1616 may be large enough in capacity to store multiple instances of neural networks for redundancy and safety. The data store(s) 1612 may comprise L2 and/or L3 cache(s) 1612, for example. The memory(ies) 1615 may include SRAM, LPDDR5, and/or other memory types. For example, the memory(ies) 1615 may include 4 MB of SRAM, 32 GB and/or 64 GB 256-bit LPDDR5 at 204.8 GB/s, 8 GB and/or 16 GB 128-bit LPDDR 5 at 102.4 GB/s, and/or other memory types and sizes. Reference to the data store(s) 1616 may include reference to the memory associated with the PVA 1607, OFA 1611, DLA 1609, and/or other accelerator(s) 1614, as described herein.

The data store(s) 116 may include various storage types, such as eMMC, NVMe, etc. For example, the SoC(s) 1604 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1616 and/or other storage may be accessed via, e.g., NVMe, using PCI Express (PCIe), RDMA, TCP, and/or other protocols.

The SoC(s) 1604 may include one or more processor(s) 1610 (e.g., embedded processors). The processor(s) 1610 may include a boot and power management processor (BPMP) 1653, that may be a dedicated processor and subsystem to handle boot power and management functions and related security enforcement. The BPMP 1653 may be a part of the SoC(s) 1604 boot sequence and may provide runtime power management services. The BPMP 1653 may provide clock and voltage programming, assistance in system low power state transitions, management of SoC(s) 1604 thermals and temperature sensors, and/or management of the SoC(s) 1604 power states. Each temperature sensor may be implemented as a ring-oscillator whose output frequency is proportional to temperature, and the SoC(s) 1604 may use the ring-oscillators to detect temperatures of the CPU(s) 1606, GPU(s) 1608, accelerator(s) 1614, and/or other components. If temperatures are determined to exceed a threshold, BPMP 1653 may enter a temperature fault routine and put the SoC(s) 1604 into a lower power state and/or put the machine 1600 into a chauffeur to safe stop mode (e.g., bring the machine 1600 to a safe stop).

The processor(s) 1610 may further include a set of embedded processors that may serve as an audio processing engine (APE) 1655. The APE 1655 may be an audio subsystem that enables full hardware support for multi-channel audio over multiple interfaces, and a broad and flexible range of audio I/O interfaces. In some examples, the APE 1655 is a dedicated processor core with a digital signal processor with dedicated RAM.

The processor(s) 1610 may further include an always on processor engine (AOPE) 1657 that may provide necessary hardware features to support low power sensor management and wake use cases. The AOPE 1657 may include a processor core, a tightly coupled RAM, supporting peripherals (e.g., timers and interrupt controllers), various I/O controller peripherals, and routing logic.

The processor(s) 1610 may further include a safety processor(s) 1613 (alternatively referred to as “safety island 1613”), which may include a safety cluster engine that includes a dedicated processor or processor subsystem to handle safety management for automotive, robotics, and/or other applications. The safety processor(s) 1613—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1613 may include a discrete processor(s), such that fault of other system components may not impact the performance and availability of the safety processor 1613.

The processor(s) 1610 may further include a real-time or near real-time sensor engine (SE) 1659 that may include a dedicated processor subsystem for handling real-time or near real-time camera, LiDAR, RADAR, and/or other sensor modality management.

The processor(s) 1610 may further include one or more image signal processors (ISPs) 1627, which may include a high-dynamic range signal processor and/or a hardware engine that is part of one or more sensor processing pipelines.

The processor(s) 1610 may include a video image compositor (VIC) 1661 that may be a processing block (e.g., implemented on a microprocessor) that implements video post-processing functions needed by a video playback application to produce the final image for the player window. The VIC 1661 may perform lens distortion correction on wide-view camera(s) 1668B, surround camera(s) 1668D, in-cabin monitoring camera sensors, and/or other camera sensors with distorted fields of view.

A VIC 1661 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1661 may also be configured to perform stereo rectification on input stereo lens frames. The video image compositor may further be used for user interface composition when the operating system desktop is in use, and the GPU(s) 1608 is not required to continuously render new surfaces. Even when the GPU(s) 1608 is powered on and active doing 3D rendering, the video image compositor may be used to offload the GPU(s) 1608 to improve performance and responsiveness.

The SoC(s) 1604 may further include a broad range of peripheral interfaces for input/output (I/O) 1625, such as to enable communication with peripherals, audio codecs, power management, and/or other devices. The SoC(s) 1604 may be used to process data from cameras (e.g., connected over Gigabit Multimedia Serial Link and/or Ethernet), sensors (e.g., LiDAR sensor(s) 1664, RADAR sensor(s) 1660, etc. that may be connected over Ethernet), data from bus 1602 (e.g., speed of machine 1600, steering wheel position, etc.), data from GNSS sensor(s) 1658 (e.g., connected over Ethernet or CAN bus). The SoC(s) 1604 may further include dedicated high-performance mass storage controllers that may include their own DMA engines, and that may be used to free the CPU(s) 1606 from routine data management tasks. In some embodiments, the SoC(s) 1604 I/O 1625 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1625 elements, components, or features.

The SoC(s) 1604 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1604 may include an RJ45 connector with up to 10 GbE, a 1 GbE connector, and/or other networking connector types.

The SoC(s) 1604 may include one or more digital signal processors (DSPs) 1643. For example, the DSP(s) 1643 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 1604 may include one or more video encoders 1619 and/or one or more video decoders 1621. For example, the video encoder(s) 1619 may include a hardware-based (e.g., as part of the GPU(s) 1608) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1621 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1621 may be hardware-based (e.g., as part of the GPU(s) 1608).

The SoC(s) 1604 may include one or more general compute acceleration clusters (GCAC(s)) 1629. For example, the GCAC(s) 1629 may include various processor types that may be used to accelerate compute, such as one or more vector microcode processors (VMPs) 1633, one or more multi-threaded processing clusters (MPCs) 1631, one or more programmable macro arrays (PMA(s)) 1635, and/or one or more other processor types. For example, the GCAC(s) 1629 may include a PMA 1635, two VMPs 1633, and 2 MPCs 1631.

The SoC(s) 1604 may include one or more vector microcode processors (VMPs) 1633. The VMP(s) 1633, in embodiments, may include a wide vector (very long instruction word (VLIW) and single instruction multiple data (SIMD)) machine with performing various operations, such as short integral type operations common in computer vision and deep learning algorithms.

The SoC(s) 1604 may include one or more multi-threaded processing clusters (MPCs) 1631. The MPC(s) 1631 may include a processing cluster that be, in embodiments, more versatile than a GPU, and with higher efficiency than a CPU. For example, the MPC(s) 1631 may include a multi-threaded processor that allows multiple threads to share resources and execute instructions concurrently.

The SoC(s) 1604 may include one or more programmable macro arrays (PMA(s)) 1635. The PMA(s) 1635 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1604 may include one or more display processing units (DPUs) 1645 for performing hardware-accelerated image processing. For example, the DPU(s) 1645 may retrieve pixel data from memory 1615 and send it to a display peripheral through standard interfaces. As such, the DPU(s) 1645 may handle display processing and rendering for in-machine and/or on-machine displays.

The SoC(s) 1604 may include one or more application processing units (APUs) 1639. For example, the APU(s) 1639 may include a quad or dual-core processor with 48 KB/32 KB L1 cache with parity and ECC, along with a 1 MB L2 cache with ECC. The APU(s) 1639 may support NEON instructions and single and double precision floating point operations.

The SoC(s) 1604 may include one or more real-time processing units (RTPUs) 1669. The RTPU(s) 1669 may include a dual-core processor with 32 KB/32 KB L1 cache, and 256 KB TCM with ECC. The RTPU(s) 1669 may support single and double precision floating point operations.

The SoC(s) 1604 may include one or more built-in self-test (BIST) components 1637. For example, the BIST component(s) 1637 may include memory BIST (MBIST) to test memories of the system and/or logic BIST (LBIST) to test logic of the system. The BIST components 1637 may include embedded logic for directly testing logic and/or memory of the system.

The SoC(s) 1604 may include one or more dynamically reconfigurable processors (DRPs) 1671. For example, the DRP(s) 1671 may be used for accelerating various computing operations. For example, the DRP(s) 1671 may be combined, in embodiments, with a MAC unit for use as an AI accelerator. In embodiments, the DRP(s) 1671 may execute applications while dynamically switching the circuit connection configuration of the arithmetic units (e.g., ALUs) on the chip at each operating clock according to the content to be processed. Since only the necessary arithmetic circuits are used, the DRP(s) 1671 may consume less power than with CPU processing and can achieve higher speed. Furthermore, compared to CPUs, where frequent external memory accesses due to cache misses and other causes will degrade performance, the DRP(s) 1671 can build the necessary data paths in hardware ahead of time, resulting in less performance degradation and less variation in operating speed (jitter) due to memory accesses. The DRP(s) 1671 may include a dynamic loading function that switches the circuit connection information each time the algorithm changes, enabling processing with limited hardware resources, even in robotic/automotive applications that require processing of multiple algorithms.

In some embodiments, the accelerator(s) 1614 may include an OpenCV accelerator for speeding up processing of OpenCV, an open-source industry standard library for computer vision processing. In some embodiments, the combination of one or more DRP(s) 1671 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1604 may include various compute engines (e.g., processors 1610, CPUs 1606, GPU(s) 1608, accelerator(s) 1614, etc.), tasks may be distributed between and among the compute engines, in some instances without common cause failures due to the discrete footprint of the compute engines. Further, because the SoC(s) 1604 may include a dedicated safety processor(s) 1613 (or safety island 1613), critical safety or redundant operations may be performed without common cause failures from the main processing components or compute engines of the SoC(s) 1614. Due to these features, the SoC(s) 1604 and/or the underlying systems of the machine 1600 may be capable of satisfying higher levels of safety—such as automotive safety integrity level (ASIL) D from the ISO 26262 standard.

FIG. 16E is a system diagram for communication between a cloud-based server(s) (e.g., in a data center, such as those described herein) and the example autonomous or semi-autonomous vehicle or machine 1600 of FIG. 16A, in accordance with some embodiments of the present disclosure. The system 1676 may include a server(s) 1678, a network(s) 1690, and a machine(s) 1600. The server(s) 1678 may include a plurality of GPUs 1684(A)-1684(H) (collectively referred to herein as GPUs 1684), switches 1682(A)-1682(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 1680(A)-1680(B) (collectively referred to herein as CPUs 1680), accelerators, and/or other processor types. The GPUs 1684, the CPUs 1680, and the PCIe switches may be interconnected with high-speed interconnects such as, for example and without limitation, NVLink interfaces 1688 developed by NVIDIA and/or PCIe connections 1686. In some examples, the GPUs 1684 are connected via NVLink and/or NVSwitch SoC and the GPUs 1684 and the PCIe switches 1682 are connected via PCIe interconnects. Although eight GPUs 1684, two CPUs 1680, and two PCIe switches are illustrated, this is not intended to be limiting. Depending on the embodiment, each of the server(s) 1678 may include any number of GPUs 1684, CPUs 1680, and/or PCIe switches. For example, the server(s) 1678 may each include eight, sixteen, thirty-two, and/or more GPUs 1684.

The server(s) 1678 may receive, over the network(s) 1690 and from the machine(s) 1600, sensor data indicating information about new or previously unexplored locations, and/or sensor data indicating changes to previously seen/stored locations (e.g., unexpected or changed road conditions, such as recently commenced road-work). The server(s) 1678 may transmit, over the network(s) 1690 and to the machine(s) 1600, neural networks 1692, updated neural networks 1692, map information 1694, etc., including information regarding traffic and road conditions. The updates to the map information 1694 may include updates for the HD map 1622, SD map, navigation map, etc., such as information regarding construction sites, potholes, detours, flooding, and/or other obstructions. In some examples, the neural networks 1692, the updated neural networks 1692, the map information 1694, and/or the other information may have resulted from new training and/or experiences represented in data received from any number of machine(s) 1600 in the environment, and/or based on training performed at a datacenter (e.g., using the server(s) 1678 and/or other servers).

The server(s) 1678 may be used to train machine learning models (e.g., neural networks) based on training data. The training data may be generated by the machine(s) 1600, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1600 (e.g., transmitted to the machine(s) 1600 over the network(s) 1690, and/or the machine learning models may be used by the server(s) 1678 to remotely monitor and/or control the machine(s) 1600.

In some examples, the server(s) 1678 may receive data from the machine(s) 1600 and apply the data to up-to-date real-time neural networks for real-time intelligent inferencing. The server(s) 1678 may include deep-learning supercomputers and/or dedicated AI computers powered by GPU(s) 1684, such as a DGX and DGX Station machines developed by NVIDIA. However, in some examples, the server(s) 1678 may include deep learning infrastructure that use only CPU-powered datacenters.

The deep-learning infrastructure of the server(s) 1678 may be capable of fast, real-time inferencing, and may use that capability to evaluate and verify the health of the processors, software, and/or associated hardware in the machine 1600. For example, the deep-learning infrastructure may receive periodic updates from the machine 1600, such as a sequence of images and/or objects that the machine 1600 has located in that sequence of images (e.g., via computer vision and/or other machine learning object classification techniques). The deep-learning infrastructure may run its own neural network to identify the objects and compare them with the objects identified by the machine 1600 and, if the results do not match and the infrastructure concludes that the AI in the machine 1600 is malfunctioning, the server(s) 1678 may transmit a signal to the machine 1600 instructing a fail-safe computer of the machine 1600 to assume control, notify the passengers, and complete a safety maneuver or operation-such as to slow down, hand control back to a driver, come to a stop, and/or pull over/shut down.

For inferencing, the server(s) 1678 may include the GPU(s) 1684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 17 is a system diagram illustrating a three computer ecosystem 1700, including a first computing system 1702 for generating or creating artificial intelligence (AI)—such as AI training and validation data, a second computing system 1704 for training artificial intelligence, and a third computing system 1706 (which may include or correspond to the SoC(s) 1604 of FIGS. 16A-16E) deploying the AI at the edge, in accordance with at least some embodiments of the present disclosure. For example, to develop and deploy embodied or physical AI, the three computer ecosystem 1700 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1600 and their worlds. By doing so, simulation of machine(s) 1600 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 1600 can perform safely in controlled settings.

The computing system 1704 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 1600 to understand natural language and emulate movements by observing human actions. The computing system 1704 may include a platform that incorporates software, infrastructure, and expertise in a modern, unified AI development and training solution. The computing system 1704 may include individual computing devices 1710 (e.g., NVIDIA's DGX B200, H200, etc.) and/or any number of computing devices 1710 in a data center infrastructure 1712 (e.g., NVIDIA's DGX SuperPOD).

For example, the individual computing devices 1710 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1710 may include memory (e.g., 4 TB memory, and storage (e.g., OS storage of 2×1.9 TB NVMe M.2, and internal storage of 8×3.84 TB NVMe U.2). The computing devices 1710 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1710 may further include, e.g., dual port quad small form-factor pluggable (QSFFP) data processing units (DPUs) (e.g., 2 dual-port QSFP 112 DPUs—such as NVIDIA's BlueField-3 DPUs), providing up to 400 Gb/s InfiniBand/Ethernet. The computing device(s) 1710 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1710 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1710 may include a smart host channel adapter (HCA) (e.g., NVIDIA's ConnectX-7) to provide ultra-low latency, 400 Gb/s throughput for in-network computing acceleration engines.

The data center infrastructure 1712 may include any number of the computing devices 1710, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1710) to thousands, job scheduling and orchestration to ensure hassle-free execution of every developer's job, AI workflow management and machine learning operations (MLOps) to move more models from prototype to production, and enterprise software to speed developer success.

The computing system 1702 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1702 allows developers to use simulation frameworks to simulate and validate robot models, and/or to generate massive amounts of physically-based synthetic data to bootstrap model training. The computing system 1702 may support learning frameworks that power robot reinforcement learning and imitation learning, to accelerate robot policy training and refinement. For example, the computing system 1702 may be used to generate any number of simulations 1708—such as within NVIDIA's OMNIVERSE. The computing system 1702 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1702 may host or support a native OpenUSD software platform enabling enterprises to connect 3D pipelines and develop advanced, real-time 3D applications for industrial digitalization. With powerful ray-tracing-accelerated AI and graphics capabilities, the computing system 1702 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1702 may include individual computing devices 1714 (e.g., NVIDIA's OVX L40S Server) and/or any number of computing devices 1714 in a data center infrastructure 1716 (e.g., NVIDIA's OVX Systems).

The computing device(s) 1714 (which may include a server) may include CPUs (e.g., 2 CPUs with 32 cores each), and GPUs (e.g., 4 or 8 GPUs, each including 48 GB GDDR 6 with ECC memory, 864 GB/s memory bandwidth, PCIe Gen 4×16:64 GB/s bidirectional interconnect interface, 18,176 CUDA cores, 142 ray tracing (RT) cores, and 568 tensor cores). The computing devices 1714 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some embodiments, the NICs used for the computing device(s) 1714 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1714 may include a smart host channel adapter (HCA) (e.g., NVIDIA's ConnectX-7) to provide ultra-low latency, 400 Gb/s throughput for in-network computing acceleration engines. The computing device(s) 1714 may include a host memory (e.g., 384 Gb DDR 5 ECC for 4 GPUs, or 768 Gb DDR 5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 1712, the data center infrastructure 1716 may allow for any number of computing device(s) 1714 to be combined in cluster configuration according to a reference architecture.

The computing system 1706 may be used to deploy trained AI models on a runtime computer-such as the SoC(s) 1604 described herein. For example, these computing systems 1706 may be designed for compact, on-board computing needs, including an ensemble of models for control policy, vision and language models, etc., deployed on a power-efficient on-board edge computing system 1706. Details of components, features, and capabilities of the computing system 1706 may be described in more detail herein with respect to FIGS. 16A-16E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 18 is a block diagram of an example generative language model system 1800 suitable for use in implementing at least some embodiments of the present disclosure. In the example illustrated in FIG. 18, the generative language model system 1800 includes a retrieval augmented generation (RAG) component 1892, an input processor 1805, a tokenizer 1810, an embedding component 1820, plug-ins/APIs 1895, and a generative language model (LM) 1830 (which may include an LLM, a VLM, a MMLM, a VLA model, etc.).

At a high level, the input processor 1805 may receive an input 1801 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1830 (e.g., LLM/VLM/MMLM/etc.). In some embodiments, the input 1801 includes plain text in the form of one or more sentences, paragraphs, and/or documents. Additionally or alternatively, the input 1801 may include numerical sequences, precomputed embeddings (e.g., word or sentence embeddings), and/or structured data (e.g., in tabular formats, JSON, or XML). In some implementations in which the generative LM 1830 is capable of processing multi-modal inputs, the input 1801 may combine text (or may omit text) with image data, audio data, video data, design data, USD data, and/or other types of input data, such as but not limited to those described herein. Taking raw input text as an example, the input processor 1805 may prepare raw input text in various ways. For example, the input processor 1805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1805 may remove stopwords to reduce noise and focus the generative LM 1830 on more meaningful content. The input processor 1805 may apply text normalization (TN), for example, by converting all characters to lowercase, removing accents, and/or or handling special cases like contractions or abbreviations to ensure consistency (e.g., converting ¼ to one quarter). Similarly, the input processor 1805 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1892 (which may include one or more RAG models, and/or may be performed using the generative LM 1830 itself) may be used to retrieve additional information to be used as part of the input 1801 or prompt. RAG may be used to enhance the input to the LLM/VLM/MMLM/etc. with external knowledge, so that answers to specific questions or queries or requests are more relevant-such as in a case where specific knowledge is required. The RAG component 1892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1801 may be generated using the query or input to the model (e.g., a question, a request, etc.) in addition to data retrieved using the RAG component 1892. In some embodiments, the input processor 1805 may analyze the input 1801 and communicate with the RAG component 1892 (or the RAG component 1892 may be part of the input processor 1805, in embodiments) in order to identify relevant text and/or other data to provide to the generative LM 1830 as additional context or sources of information from which to identify the response, answer, or output 1890, generally. For example, where the input indicates that the user is interested in a desired tire pressure for a particular make and model of vehicle, the RAG component 1892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1892 may retrieve a prior stored conversation history—or at least a summary thereof—and include the prior conversation history along with the current ask/request as part of the input 1801 to the generative LM 1830.

The RAG component 1892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1892 and the embeddings of the chunks along with the embeddings of the query may be compared to identify the most similar/related embeddings to the query, which may be supplied to the generative LM 1830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1830 to understand morphological variations and handle out-of-vocabulary words more effectively. Character-based tokenization represents each character as a separate token, enabling the generative LM 1830 to process text at a fine-grained level. The choice of tokenization strategy may depend on factors such as the language being processed, the task at hand, and/or characteristics of the training dataset. As such, the tokenizer 1810 may convert the (e.g., processed) text into a structured format according to tokenization schema being implemented in the particular embodiment.

The embedding component 1820 may use any known embedding technique to transform discrete tokens into (e.g., dense, continuous vector) representations of semantic meaning. For example, the embedding component 1820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1801 includes image data/video data/etc., the input processor 1801 may resize the data to a standard size compatible with format of a corresponding input channel and/or may normalize pixel values to a common range (e.g., 0 to 1) to ensure a consistent representation, and the embedding component 1820 may encode the image data using any known technique (e.g., using one or more convolutional neural networks (CNNs) to extract visual features). In some implementations in which the input 1801 includes audio data, the input processor 1801 may resample an audio file to a consistent sampling rate for uniform processing, and the embedding component 1820 may use any known technique to extract and encode audio features—such as in the form of a spectrogram (e.g., a mel-spectrogram). In some implementations in which the input 1801 includes video data, the input processor 1801 may extract frames or apply resizing to extracted frames, and the embedding component 1820 may extract features such as optical flow embeddings or video embeddings and/or may encode temporal information or sequences of frames. In some implementations in which the input 1801 includes multi-modal data, the embedding component 1820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1830 and/or other components of the generative LM system 1800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1820 may apply an encoded representation of the input 1801 to the generative LM 1830, and the generative LM 1830 may process the encoded representation of the input 1801 to generate an output 1890, which may include responsive text and/or other types of data.

As described herein, in some embodiments, the generative LM 1830 may be configured to access or use—or capable of accessing or using—plug-ins/APIs 1895 (which may include one or more plug-ins, application programming interfaces (APIs), databases, data stores, repositories, etc.). For example, for certain tasks or operations that the generative LM 1830 is not ideally suited for, the model may have instructions (e.g., as a result of training, and/or based on instructions in a given prompt, such as those retrieved using the RAG component 1892) to access one or more plug-ins/APIs 1895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1895 to the plug-in/API 1895, the plug-in/API 1895 may process the information and return an answer to the generative LM 1830, and the generative LM 1830 may use the response to generate the output 1890. This process may be repeated—e.g., recursively—for any number of iterations and using any number of plug-ins/APIs 1895 until an output 1890 that addresses each ask/question/request/process/operation/etc. from the input 1801 can be generated. As such, the model(s) may not only rely on its own knowledge from training on a large dataset(s) and/or from data retrieved using the RAG component 1892, but also on the expertise or optimized nature of one or more external resources-such as the plug-ins/APIs 1895.

In some embodiments, one or more transformer engines (TEs) may be implemented. The transformer engine may use micro-tensor scaling to optimize performance and accuracy-such as to enable 16-bit floating point (FP 16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches-such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 19 is a block diagram of an example computing device(s) 1900 suitable for use in implementing some embodiments of the present disclosure. Computing device 1900 may include an interconnect system 1902 that directly or indirectly couples the following devices: memory 1904, one or more central processing units (CPUs) 1906, one or more graphics processing units (GPUs) 1908, a communication interface 1910, input/output (I/O) ports 1912, input/output components 1914, a power supply 1916, one or more presentation components 1918 (e.g., display(s), speaker(s), etc.), and one or more logic units 1920. In at least one embodiment, the computing device(s) 1900 may comprise one or more virtual machines (VMs), and/or any of the components thereof may comprise virtual components (e.g., virtual hardware components). For non-limiting examples, one or more of the GPUs 1908 may comprise one or more vGPUs, one or more of the CPUs 1906 may comprise one or more vCPUs, and/or one or more of the logic units 1920 may comprise one or more virtual logic units. As such, a computing device(s) 1900 may include discrete components (e.g., a full GPU dedicated to the computing device 1900), virtual components (e.g., a portion of a GPU dedicated to the computing device 1900), or a combination thereof.

Although the various blocks of FIG. 19 are shown as connected via the interconnect system 1902 with lines, this is not intended to be limiting and is for clarity only. For example, in some embodiments, a presentation component 1918, such as a display device, may be considered an I/O component 1914 (e.g., if the display is a touch screen). As another example, the CPUs 1906 and/or GPUs 1908 may include memory (e.g., the memory 1904 may be representative of a storage device in addition to the memory of the GPUs 1908, the CPUs 1906, and/or other components). As such, the computing device of FIG. 19 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 19.

The interconnect system 1902 may represent one or more links or busses, such as an address bus, a data bus, a control bus, or a combination thereof. The interconnect system 1902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1906 may be directly connected to the memory 1904. Further, the CPU 1906 may be directly connected to the GPU 1908. Where there is direct, or point-to-point connection between components, the interconnect system 1902 may include a PCIe link to carry out the connection. In these examples, a PCI bus need not be included in the computing device 1900.

The memory 1904 may include any of a variety of computer-readable media. The computer-readable media may be any available media that may be accessed by the computing device 1900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1906 may be configured to execute at least some of the computer-readable instructions to control one or more components of the computing device 1900 to perform one or more of the methods and/or processes described herein. The CPU(s) 1906 may each include one or more cores (e.g., one, two, four, eight, twenty-eight, seventy-two, etc.) that are capable of handling a multitude of software threads simultaneously. The CPU(s) 1906 may include any type of processor, and may include different types of processors depending on the type of computing device 1900 implemented (e.g., processors with fewer cores for mobile devices and processors with more cores for servers). For example, depending on the type of computing device 1900, the processor may be an Advanced RISC Machines (ARM) processor implemented using Reduced Instruction Set Computing (RISC) or an x86 processor implemented using Complex Instruction Set Computing (CISC). The computing device 1900 may include one or more CPUs 1906 in addition to one or more microprocessors or supplementary co-processors, such as math co-processors.

In addition to or alternatively from the CPU(s) 1906, the GPU(s) 1908 may be configured to execute at least some of the computer-readable instructions to control one or more components of the computing device 1900 to perform one or more of the methods and/or processes described herein. One or more of the GPU(s) 1908 may be an integrated GPU (e.g., with one or more of the CPU(s) 1906 and/or one or more of the GPU(s) 1908 may be a discrete GPU. In embodiments, one or more of the GPU(s) 1908 may be a coprocessor of one or more of the CPU(s) 1906. The GPU(s) 1908 may be used by the computing device 1900 to render graphics (e.g., 3D graphics) or perform general purpose computations. For example, the GPU(s) 1908 may be used for General-Purpose computing on GPUs (GPGPU). The GPU(s) 1908 may include hundreds or thousands of cores that are capable of handling hundreds or thousands of software threads simultaneously. The GPU(s) 1908 may generate pixel data for output images in response to rendering commands (e.g., rendering commands from the CPU(s) 1906 received via a host interface). The GPU(s) 1908 may include graphics memory, such as display memory, for storing pixel data or any other suitable data, such as GPGPU data. The display memory may be included as part of the memory 1904. The GPU(s) 1908 may include two or more GPUs operating in parallel (e.g., via a link). The link may directly connect the GPUs (e.g., using NVLINK) or may connect the GPUs through a switch (e.g., using NVSwitch). When combined together, each GPU 1908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1906 and/or the GPU(s) 1908, the logic unit(s) 1920 may be configured to execute at least some of the computer-readable instructions to control one or more components of the computing device 1900 to perform one or more of the methods and/or processes described herein. In embodiments, the CPU(s) 1906, the GPU(s) 1908, and/or the logic unit(s) 1920 may discretely or jointly perform any combination of the methods, processes and/or portions thereof. One or more of the logic units 1920 may be part of and/or integrated in one or more of the CPU(s) 1906 and/or the GPU(s) 1908 and/or one or more of the logic units 1920 may be discrete components or otherwise external to the CPU(s) 1906 and/or the GPU(s) 1908. In embodiments, one or more of the logic units 1920 may be a coprocessor of one or more of the CPU(s) 1906 and/or one or more of the GPU(s) 1908.

Examples of the logic unit(s) 1920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1910 may include one or more receivers, transmitters, and/or transceivers that allow the computing device 1900 to communicate with other computing devices via an electronic communication network, included wired and/or wireless communications. The communication interface 1910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1920 and/or communication interface 1910 may include one or more data processing units (DPUs) to transmit data received over a network and/or through interconnect system 1902 directly to (e.g., a memory of) one or more GPU(s) 1908.

The I/O ports 1912 may allow the computing device 1900 to be logically coupled to other devices including the I/O components 1914, the presentation component(s) 1918, and/or other components, some of which may be built in to (e.g., integrated in) the computing device 1900. Illustrative I/O components 1914 include a microphone, mouse, keyboard, joystick, game pad, game controller, satellite dish, scanner, printer, wireless device, etc. The I/O components 1914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1900. The computing device 1900 may be include depth cameras, such as stereoscopic camera systems, infrared camera systems, RGB camera systems, touchscreen technology, and combinations of these, for gesture detection and recognition. Additionally, the computing device 1900 may include accelerometers or gyroscopes (e.g., as part of an inertia measurement unit (IMU)) that allow detection of motion. In some examples, the output of the accelerometers or gyroscopes may be used by the computing device 1900 to render immersive augmented reality or virtual reality.

The power supply 1916 may include a hard-wired power supply, a battery power supply, or a combination thereof. The power supply 1916 may provide power to the computing device 1900 to allow the components of the computing device 1900 to operate.

The presentation component(s) 1918 may include a display (e.g., a monitor, a touch screen, a television screen, a heads-up-display (HUD), other display types, or a combination thereof), speakers, and/or other presentation components. The presentation component(s) 1918 may receive data from other components (e.g., the GPU(s) 1908, the CPU(s) 1906, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1900 of FIG. 19—e.g., each device may include similar components, features, and/or functionality of the computing device(s) 1900. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1900 described herein with respect to FIG. 19. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

A. A method comprising: obtaining image data representing an image of an occupancy map associated with an environment, the occupancy map indicating at least one or more occupied areas and one or more unoccupied areas in the environment; positioning one or more first nodes of a waypoint graph at one or more first locations in the image, the one or more first locations corresponding to one or more perimeters associated with the one or more occupied areas; positioning, based at least on the one or more first locations of the one or more first nodes, one or more second nodes of the waypoint graph at one or more second locations in the image corresponding to the one or more unoccupied areas; and generating, using one or more geometric graph generation models, one or more edges between nodes of the waypoint graph, the nodes including at least the one or more first nodes and the one or more second nodes.
B. The method of paragraph A, further comprising: determining that the one or more second locations locally maximize one or more distances between the one or more first nodes and the one or more second nodes; wherein the positioning of the one or more second nodes of the waypoint graph at the one or more second locations is based at least on the determining that the one or more second locations locally maximize the one or more distances.
C. The method of any one of paragraphs A-B, further comprising: determining that one or more distances between the one or more first nodes and the one or more second nodes meet or exceed a threshold, wherein the positioning of the one or more second nodes at the one or more second locations is based at least on the one or more distances meeting or exceeding the threshold.
D. The method of any one of paragraphs A-C, further comprising: positioning one or more third nodes of the waypoint graph at one or more third locations in the image within the one or more unoccupied areas; and determining that one or more distances between the one or more first nodes and the one or more third nodes meet or exceed a threshold, wherein the positioning of the one or more second nodes at the one or more second locations is based at least on the one or more distances meeting or exceeding the threshold.
E. The method of any one of paragraphs A-D, further comprising: identifying, in the waypoint graph, at least a group of the nodes that includes at least a first member node located within a threshold distance to a second member node; and merging the group of the nodes into a representative node while preserving connectivity of at least an edge of the one or more edges.
F. The method of any one of paragraphs A-E, further comprising: positioning one or more third nodes of the waypoint graph at one or more third locations in the image that locally maximize one or more distances between the one or more third nodes and at least one of the one or more first nodes or the one or more second nodes; determining that the one or more distances between the one or more third nodes and the at least one of the one or more first nodes or the one or more second nodes meet or exceed a threshold; and determining to maintain the one or more third nodes in the waypoint graph based at least on the one or more distances meeting or exceeding the threshold.
G. The method of any one of paragraphs A-F, wherein the generating of the one or more edges between the nodes of the waypoint graph using the one or more geometric graph generation models comprises, at least: forming one or more triangles between one or more groups of the nodes of the waypoint graph using one or more Delaunay triangulation models; and generating the one or more edges between one or more subsets of the nodes that share the one or more triangles, wherein the one or more edges correspond to one or more straight-line paths that avoid the one or more occupied areas and satisfy one or more safety constraints with respect to the one or more occupied areas.
H. A system comprising one or more processors to: determine one or more first locations for one or more first nodes of a waypoint graph as being within a threshold distance of one or more perimeters associated with one or more occupied areas of an environment; determine, based at least on the one or more first locations, one or more second locations for one or more second nodes of the waypoint graph as being within one or more unoccupied areas of the environment; generate one or more edges of the waypoint graph connecting at least the one or more second nodes with the one or more first nodes; and send the waypoint graph to one or more machines configured to operate in the environment.
I. The system of paragraph H, the one or more processors further to: determine that one or more distances between the one or more first nodes and the one or more second nodes meet or exceed a second threshold, wherein the determination of the one or more second locations is based at least on the one or more distances meeting or exceeding the second threshold.
J. The system of any one of paragraphs H-I, the one or more processors further to: determine that one or more distances between the one or more first nodes and one or more third nodes of the waypoint graph meet or exceed a threshold, wherein the determination of the one or more second locations is based at least on the one or more distances meeting or exceeding the threshold.
K. The system of any one of paragraphs H-J, the one or more processors further to: determine one or more third locations for one or more third nodes of the waypoint graph, wherein the one or more third locations locally maximize one or more distances between the one or more third nodes and at least one of the one or more first nodes or the one or more second nodes; determine that the one or more distances meet or exceed a second threshold; and position the one or more third nodes in the waypoint graph based at least on the one or more distances meeting or exceeding the second threshold.
L. The system of any one of paragraphs H-K, the one or more processors further to: generate one or more distance maps associated with the one or more unoccupied areas of the environment, the one or more distance maps indicating, for locations in the one or more unoccupied areas, distances to at least one of a nearest node of the waypoint graph or a nearest occupied area of the environment; and determine to generate the one or more edges based at least on a determination that at least a threshold number of the distances are less than a second threshold.
M. The system of any one of paragraphs H-L, the one or more processors further to: generate image data representing an image depicting one or more distance maps associated with the one or more unoccupied areas of the environment, wherein pixels in the image correspond to respective locations in the environment and values of the pixels indicate distances of the respective locations to at least one of a nearest node of the waypoint graph or a nearest occupied area of the environment, wherein the determination of the one or more second locations is based at least on the values of the pixels.
N. The system of any one of paragraphs H-M, the one or more processors further to: identify at least one group of nodes within the waypoint graph as including at least a first member node located within a second threshold distance of a second member node; and merge, based at least on the identification, the group of nodes into a representative node.
O. The system of any one of paragraphs H-N, wherein the generation of the one or more edges comprises, at least: forming one or more triangles between one or more groups of nodes using one or more Delaunay triangulation models; and generating the one or more edges between subsets of the nodes that share the one or more triangles.
P. The system of any one of paragraphs H-O, wherein the one or more edges correspond to one or more straight-line paths that avoid one or more occupied areas indicated in the occupancy map and satisfy one or more safety constraints with respect to the one or more occupied areas.
Q. The system of any one of paragraphs H-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package; a system incorporating one or more virtual machines (VMs); a system implemented at least partially in a data center; or a system implemented at least partially using cloud computing resources.
R. One or more processors comprising processing circuitry to: cause one or more machines to perform one or more planning, navigation, or control operations associated with following a path through an environment, the path at least partially determined using one or more waypoint graphs indicating one or more possible paths through the environment, wherein the one or more waypoint graphs are generated, at least, by: determining one or more first locations for one or more first nodes of the one or more waypoint graphs based at least on one or more perimeters associated with one or more occupied areas of the environment; determining, based at least on the one or more first locations, one or more second locations for one or more second nodes of the one or more waypoint graphs corresponding to one or more unoccupied areas of the environment; and generating one or more edges of the one or more waypoint graphs connecting at least the one or more second nodes with the one or more first nodes.
S. The one or more processors of paragraph R, wherein the one or more waypoint graphs are generated, at least, by further: identifying, within the one or more waypoint graphs, at least a group of nodes including at least a first member node located within a threshold distance of a second member node; and updating the one or more waypoint graphs based at least on merging the group of nodes.
T. The one or more processors of any one of paragraphs R-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining image data representing an image of an occupancy map associated with an environment, the occupancy map indicating at least one or more occupied areas and one or more unoccupied areas in the environment;
positioning one or more first nodes of a waypoint graph at one or more first locations in the image, the one or more first locations corresponding to one or more perimeters associated with the one or more occupied areas;
positioning, based at least on the one or more first locations of the one or more first nodes, one or more second nodes of the waypoint graph at one or more second locations in the image corresponding to the one or more unoccupied areas; and
generating, using one or more geometric graph generation models, one or more edges between nodes of the waypoint graph, the nodes including at least the one or more first nodes and the one or more second nodes.

2. The method of claim 1, further comprising:
determining that the one or more second locations locally maximize one or more distances between the one or more first nodes and the one or more second nodes;
wherein the positioning of the one or more second nodes of the waypoint graph at the one or more second locations is based at least on the determining that the one or more second locations locally maximize the one or more distances.

3. The method of claim 1, further comprising:
determining that one or more distances between the one or more first nodes and the one or more second nodes meet or exceed a threshold,
wherein the positioning of the one or more second nodes at the one or more second locations is based at least on the one or more distances meeting or exceeding the threshold.

4. The method of claim 1, further comprising:
positioning one or more third nodes of the waypoint graph at one or more third locations in the image within the one or more unoccupied areas; and
determining that one or more distances between the one or more first nodes and the one or more third nodes meet or exceed a threshold,
wherein the positioning of the one or more second nodes at the one or more second locations is based at least on the one or more distances meeting or exceeding the threshold.

5. The method of claim 1, further comprising:
identifying, in the waypoint graph, at least a group of the nodes that includes at least a first member node located within a threshold distance to a second member node; and
merging the group of the nodes into a representative node while preserving connectivity of at least an edge of the one or more edges.

6. The method of claim 1, further comprising:
positioning, one or more third nodes of the waypoint graph at one or more third locations in the image that locally maximize one or more distances between the one or more third nodes and at least one of the one or more first nodes or the one or more second nodes;
determining that the one or more distances between the one or more third nodes and the at least one of the one or more first nodes or the one or more second nodes meet or exceed a threshold; and
determining to maintain the one or more third nodes in the waypoint graph based at least on the one or more distances meeting or exceeding the threshold.

7. The method of claim 1, wherein the generating of the one or more edges between the nodes of the waypoint graph using the one or more geometric graph generation models comprises, at least:
forming one or more triangles between one or more groups of the nodes of the waypoint graph using one or more Delaunay triangulation models; and
generating the one or more edges between one or more subsets of the nodes that share the one or more triangles, wherein the one or more edges correspond to one or more straight-line paths that avoid the one or more occupied areas and satisfy one or more safety constraints with respect to the one or more occupied areas.

8. A system comprising one or more processors to:
determine one or more first locations for one or more first nodes of a waypoint graph as being within a threshold distance of one or more perimeters associated with one or more occupied areas of an environment;
determine, based at least on the one or more first locations, one or more second locations for one or more second nodes of the waypoint graph as being within one or more unoccupied areas of the environment;
generate one or more edges of the waypoint graph connecting at least the one or more second nodes with the one or more first nodes; and
send the waypoint graph to one or more machines configured to operate in the environment.

9. The system of claim 8, the one or more processors further to:
determine that one or more distances between the one or more first nodes and the one or more second nodes meet or exceed a second threshold,
wherein the determination of the one or more second locations is based at least on the one or more distances meeting or exceeding the second threshold.

10. The system of claim 8, the one or more processors further to:
determine that one or more distances between the one or more first nodes and one or more third nodes of the waypoint graph meet or exceed a threshold,
wherein the determination of the one or more second locations is based at least on the one or more distances meeting or exceeding the threshold.

11. The system of claim 8, the one or more processors further to:
determine one or more third locations for one or more third nodes of the waypoint graph, wherein the one or more third locations locally maximize one or more distances between the one or more third nodes and at least one of the one or more first nodes or the one or more second nodes;
determine that the one or more distances meet or exceed a second threshold; and
position the one or more third nodes in the waypoint graph based at least on the one or more distances meeting or exceeding the second threshold.

12. The system of claim 8, the one or more processors further to:
generate one or more distance maps associated with the one or more unoccupied areas of the environment, the one or more distance maps indicating, for locations in the one or more unoccupied areas, distances to at least one of a nearest node of the waypoint graph or a nearest occupied area of the environment; and
determine to generate the one or more edges based at least on a determination that at least a threshold number of the distances are less than a second threshold.

13. The system of claim 8, the one or more processors further to:
generate image data representing an image depicting one or more distance maps associated with the one or more unoccupied areas of the environment, wherein pixels in the image correspond to respective locations in the environment and values of the pixels indicate distances of the respective locations to at least one of a nearest node of the waypoint graph or a nearest occupied area of the environment,
wherein the determination of the one or more second locations is based at least on the values of the pixels.

14. The system of claim 8, the one or more processors further to:
identify at least one group of nodes within the waypoint graph as including at least a first member node located within a second threshold distance of a second member node; and
merge, based at least on the identification, the group of nodes into a representative node.

15. The system of claim 8, wherein the generation of the one or more edges comprises, at least:
forming one or more triangles between one or more groups of nodes using one or more Delaunay triangulation models; and
generating the one or more edges between subsets of the nodes that share the one or more triangles.

16. The system of claim 15, wherein the one or more edges correspond to one or more straight-line paths that avoid one or more occupied areas indicated in the occupancy map and satisfy one or more safety constraints with respect to the one or more occupied areas.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising processing circuitry to:
cause one or more machines to perform one or more planning, navigation, or control operations associated with following a path through an environment, the path at least partially determined using one or more waypoint graphs indicating one or more possible paths through the environment, wherein the one or more waypoint graphs are generated, at least, by:
determining one or more first locations for one or more first nodes of the one or more waypoint graphs based at least on one or more perimeters associated with one or more occupied areas of the environment;
determining, based at least on the one or more first locations, one or more second locations for one or more second nodes of the one or more waypoint graphs corresponding to one or more unoccupied areas of the environment; and
generating one or more edges of the one or more waypoint graphs connecting at least the one or more second nodes with the one or more first nodes.

19. The one or more processors of claim 18, wherein the one or more waypoint graphs are generated, at least, by further:
identifying, within the one or more waypoint graphs, at least a group of nodes including at least a first member node located within a threshold distance of a second member node; and
updating the one or more waypoint graphs based at least on merging the group of nodes.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
